(19) United States
(12) Patent Application Publication
(10) Pub. No.: US 2026/0127589 A1
(43) Pub. Date: May 7, 2026

(54) PAYMENT CODE GENERATION METHOD, PAYMENT METHOD, STORAGE MEDIUM AND DEVICE

(71) Applicant: Beijing Zitiao Network Technology Co., Ltd., Beijing (CN)

(72) Inventors: Yuepan FENG, Beijing (CN); Xuan HUANG, Beijing (CN)

(21) Appl. No.: 19/340,605

(22) Filed: Sep. 25, 2025

(30) Foreign Application Priority Data
Nov. 6, 2024 (CN) 202411578746.0

(51) Int. Cl. G06Q 20/38; G06Q 20/32; G06Q 20/40

(52) U.S. Cl. CPC G06Q 20/385; G06Q 20/3223; G06Q 20/4015

(57) ABSTRACT

The present disclosure provides a payment code generation method, a payment method, a storage medium, and a device. The method includes: displaying, in response to a generation request for a temporary payment code from a second terminal, a confirmation page of temporary payment code on a first terminal, the generation request including identity information of a second terminal user and requested amount; receiving generation confirmation information input on the confirmation page by a first terminal user able to pay with a payment code, the generation confirmation information including the identity information of the second terminal user, identity information of the first terminal user, and payment authorization information for use by the second terminal user; generating the temporary payment code according to the generation confirmation information, and sending the temporary payment code to the second terminal, the temporary payment code including a unique identifier and the payment authorization information.

### CROSS-REFERENCE TO RELATED APPLICATION

This application claims the priority to and benefits of the Chinese Patent Application, No. 202411578746.0, which was filed on Nov. 6, 2024. The aforementioned patent application is hereby incorporated by reference in its entirety.

### TECHNICAL FIELD

The present disclosure relates to the technical field of mobile payment, and in particular, to a payment code generation method and apparatus, a payment method and apparatus, a storage medium, and a device.

### BACKGROUND

With the popularity of the mobile payment technology, paying with a payment code has become a common manner of payment in daily life. Users can generate personal payment codes through mobile applications for merchants to scan and complete payments, or use their mobile phones to scan merchants' money receiving codes to make payments. However, in certain situations, users may be unable to generate or display their own payment codes due to various reasons (such as account restrictions and application malfunctions), making it difficult to complete urgent payments when needed.

Traditional solutions may include using cash, bank cards, or other modes of payment, which, however, are either inconvenient or rely on additional devices or services. Therefore, there is a need for a new solution that can quickly and securely address the problem of being unable to generate a payment code without adding to the user's burden.

### SUMMARY

The embodiments of this disclosure provide a payment code generation method and apparatus, a payment method and apparatus, a storage medium, and a device. By generating a temporary payment code by a first terminal user with payment capability of payment code and sending the temporary payment code to a second terminal user for use, payment convenience is thereby achieved.

In one aspect, the embodiments of the present disclosure provide a payment code generation method, including: displaying, in response to a generation request for a temporary payment code from a second terminal, a confirmation page of the temporary payment code on a first terminal, where the generation request includes identity information of a second terminal user and requested amount; receiving generation confirmation information input on the confirmation page by a first terminal user able to pay with a payment code, where the generation confirmation information includes the identity information of the second terminal user, identity information of the first terminal user, and payment authorization information for use by the second terminal user; and generating the temporary payment code according to the generation confirmation information, and sending the temporary payment code to the second terminal so that the second terminal can use the temporary payment code, where the temporary payment code includes a unique identifier and the payment authorization information.

In another aspect, the embodiments of the present disclosure provide a payment method, including: obtaining a generation request for a temporary payment code input by a second terminal user, where the generation request includes identity information of the second terminal user and requested amount; sending the generation request to a first terminal so that the first terminal displays, in response to the generation request, thereon a confirmation page of the temporary payment code, and receives generation confirmation information input on the confirmation page by a first terminal user able to pay with a payment code and generates the temporary payment code according to the generation confirmation information, where the generation confirmation information includes the identity information of the second terminal user, identity information of the first terminal user, and payment authorization information for use by the second terminal user, and the temporary payment code includes a unique identifier and the payment authorization information; and obtaining the temporary payment code sent by the first terminal for use by the second terminal user to perform a payment operation.

In another aspect, the embodiments of the present disclosure provide a payment code generation method, including: obtaining generation confirmation information sent by a first terminal user able to pay with a payment code via a first terminal, where the generation confirmation information is for a temporary payment code and is generated by the first terminal according to a generation request, the generation request is for the temporary payment code from a second terminal user, the generation confirmation information includes identity information of the second terminal user, identity information of the first terminal user, and payment authorization information for use by the second terminal user, and the generation request includes the identity information of the second terminal and requested amount; generating the temporary payment code associated with the second terminal user according to the generation confirmation information, where the temporary payment code includes a unique identifier and the payment authorization information; and delivering the temporary payment code to the first terminal so that the first terminal sends the temporary payment code to the second terminal, enabling the second terminal to use the temporary payment code.

In another aspect, the embodiments of the present disclosure provide a payment code generation apparatus, including: a display unit configured to display, in response to a generation request for a temporary payment code from a second terminal, a confirmation page of the temporary payment code on a first terminal, where the generation request includes identity information of a second terminal user and requested amount; a receiving unit configured to receive generation confirmation information input on the confirmation page by a first terminal user able to pay with a payment code, where the generation confirmation information includes the identity information of the second terminal user, identity information of the first terminal user, and payment authorization information for use by the second terminal user; and a processing unit configured to generate the temporary payment code according to the generation confirmation information, and send the temporary payment code to the second terminal so that the second terminal can use the temporary payment code, where the temporary payment code includes a unique identifier and the payment authorization information.

In another aspect, the embodiments of the present disclosure provide a payment apparatus, including: a first obtaining unit configured to obtain a generation request for a temporary payment code input by a second terminal user, where the generation request includes identity information of the second terminal user and requested amount; a sending unit configured to send the generation request to a first terminal so that the first terminal displays, in response to the generation request, thereon a confirmation page of the temporary payment code, and receives generation confirmation information input on the confirmation page by a first terminal user able to pay with a payment code and generates the temporary payment code according to the generation confirmation information, where the generation confirmation information includes the identity information of the second terminal user, identity information of the first terminal user, and payment authorization information for use by the second terminal user, and the temporary payment code includes a unique identifier and the payment authorization information; and a second obtaining unit configured to obtain the temporary payment code sent by the first terminal for use by the second terminal user to perform a payment operation.

In another aspect, the embodiments of the present disclosure provide a payment code generation apparatus, including: a third obtaining unit configured to obtain generation confirmation information sent by a first terminal user able to pay with a payment code via a first terminal, where the generation confirmation information is for a temporary payment code and is generated by the first terminal according to a generation request, the generation request is for the temporary payment code from a second terminal user, the generation confirmation information includes identity information of the second terminal user, identity information of the first terminal user, and payment authorization information for use by the second terminal user, and the generation request includes the identity information of the second terminal and requested amount; a generation unit configured to generate the temporary payment code associated with the second terminal user according to the generation confirmation information, where the temporary payment code includes a unique identifier and the payment authorization information; and a delivery unit configured to deliver the temporary payment code to the first terminal so that the first terminal sends the temporary payment code to the second terminal, enabling the second terminal to use the temporary payment code.

In another aspect, the embodiments of the present disclosure provide a non-transitory computer-readable storage medium, storing a computer program, where the computer program is adapted to be loaded by a processor to perform the method of any one of the foregoing embodiments.

In another aspect, the embodiments of the present disclosure provide a computer device, including a memory and a processor, where the memory stores a computer program, and the processor is configured to perform the method of any one of the foregoing embodiments by calling the computer program stored in the memory.

In another aspect, the embodiments of the present disclosure provide a computer program product, including a computer program, which, when executed by a processor, implements the method of any one of the foregoing embodiments.

According to the embodiments of the present disclosure, the first terminal displays thereon the confirmation page of the temporary payment code in response to the generation request for a temporary payment code from the second terminal, where the generation request includes the identity information of the second terminal user and the requested amount. The generation confirmation information input on the confirmation page by the first terminal user able to pay with a payment code is input, where the generation confirmation information includes the identity information of the second terminal user, the identity information of the first terminal user, and the payment authorization information for use by the second terminal user. The temporary payment code is generated according to the generation confirmation information, and sent to the second terminal so that the second terminal can use the temporary payment code, where the temporary payment code includes the unique identifier and the payment authorization information. According to the embodiments of the present disclosure, by allowing the first terminal user able to pay with a payment code to generate the temporary payment code for the second terminal user, the flexibility and the application range of the manner of payment are expanded. The problem that the second terminal user cannot make payments directly using payment codes due to technical or device restrictions is solved. The payment process is simplified. The convenience of payment is improved. The generated temporary payment code includes the unique identifier and the payment authorization information, ensuring the authenticity, validity and security of payment.

### BRIEF DESCRIPTION OF DRAWINGS

FIG. 1 is a structural schematic diagram of a payment system provided by an embodiment of the present disclosure.

FIG. 2 is a flowchart of a payment code generation method provided by an embodiment of the present disclosure.

FIG. 3 is a flowchart of a payment method provided by an embodiment of the present disclosure.

FIG. 4 is another flowchart of a payment code generation method provided by an embodiment of the present disclosure.

FIG. 5 is a schematic diagram of an interactive process of a payment system provided by an embodiment of the present disclosure.

FIG. 6 is a structural schematic diagram of a payment code generation apparatus provided by an embodiment of the present disclosure.

FIG. 7 is a structural schematic diagram of a payment apparatus provided by an embodiment of the present disclosure.

FIG. 8 is another structural schematic diagram of a payment code generation apparatus provided by an embodiment of the present disclosure.

FIG. 9 is a structural schematic diagram of a computer device provided by an embodiment of the present disclosure.

### DETAILED DESCRIPTION

The technical solutions in the embodiments of the present disclosure will be clearly and completely described below in conjunction with the accompanying drawings in the embodiments of the present disclosure. Obviously, the described embodiments are only a part of the embodiments of the present disclosure, rather than all the embodiments. Based on the embodiments in the present disclosure, all other embodiments obtained by those skilled in the art without making creative efforts shall fall within the protection scope of the present disclosure.

Embodiments of the present disclosure provide a payment code generation method and apparatus, a payment method and apparatus, a storage medium, and a device. In particular, the payment code generation method and the payment method of the embodiments of the present disclosure may be performed by a terminal device or a server. The computer device may be a terminal device or a server. The terminal device may be a smart phone, a tablet computer, a notebook computer, a desktop computer, a smart television, a smart speaker, a wearable smart device, an intelligent vehicular terminal, or the like. The terminal device may further include a client which may be a client of an application program capable of payment. For example, the client includes at least one program client and a web client. For example, the application program may be a social application program, a chatting robot application program, a customer service application program, etc. For example, the application program may also be other application programs having the chatting function, such as reading, shopping, video, music, game, financial management, office application programs having the chatting function. The server may be an independent physical server, a server cluster or a distributed system composed of a plurality of physical servers, or a cloud server providing basic cloud computing services, such as a cloud service, a cloud database, cloud computing, a cloud function, cloud storage, a network service, cloud communication, a middleware service, a domain name service, a security service, a content delivery network (CDN), and big data and artificial intelligence platforms.

The embodiments of the present disclosure may be applied to various application scenarios such as payment and payment code generation.

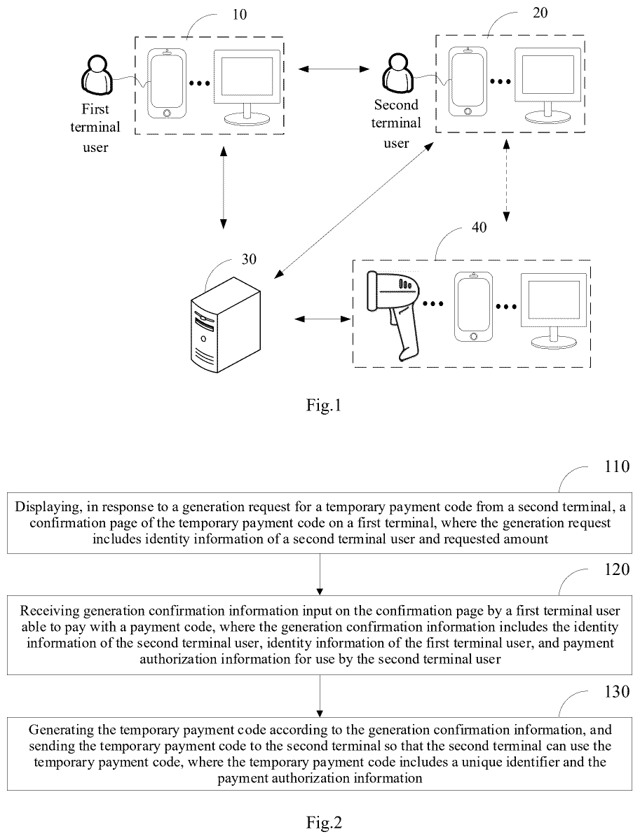

With reference to FIG. 1, FIG. 1 is a structural schematic diagram of a payment system provided by an embodiment of the present disclosure. The payment system includes a first terminal 10, a second terminal 20, a payment server 30, a scanning device 40, etc. The first terminal 10 and the second terminal 20, the first terminal 10 and the payment server 30, the second terminal 20 and the payment server 30, the payment server 30 and the scanning device 40 are connected over a network, e.g., over a wired or wireless network.

The first terminal 10 is a terminal used by a first terminal user able to pay with a payment code.

The second terminal 20 is a terminal used by a second terminal user unable to pay with a payment code.

The second terminal user unable to pay with a payment code may use a payment app configured on the second terminal 20 to generate a generation request for a temporary payment code and send the generation request to the first terminal 10 by the second terminal 20. The generation request includes identity information of the second terminal user and requested amount.

After the first terminal 10 receives the generation request from the second terminal user, the first terminal 10 displays a confirmation page of the temporary payment code in response to the generation request for a temporary payment code from the second terminal, where the generation request includes the identity information of the second terminal user and the requested amount. Generation confirmation information input on the confirmation page by the first terminal user able to pay with a payment code. The generation confirmation information includes the identity information of the second terminal user, identity information of the first terminal user, and payment authorization information for use by the second terminal user. The first terminal 10 then sends the generation confirmation information to the payment server 30.

The payment server 30 obtains the generation confirmation information for a temporary payment code that is sent by the first terminal user able to pay with a payment code via the first terminal 10. The payment server 30 generates a temporary payment code associated with the second terminal user according to the generation confirmation information, where the temporary payment code includes a unique identifier and the payment authorization information. The payment server 30 delivers the temporary payment code to the first terminal 10.

The first terminal 10 sends the received temporary payment code to the second terminal 20 so that the second terminal user presents the temporary payment code to the scanning device 40 when performing a payment operation.

The scanning device 40 generates a payment request after scanning the temporary payment code, and sends the payment request to the payment server 30. The payment request includes payment request time, amount to be paid, a unique identifier corresponding to the temporary payment code, and payment authorization information.

Upon determining that the payment request is valid according to the unique identifier and the payment authorization information, the payment server 30 preforms deduction processing on a payment account corresponding to the first terminal user according to the amount to be paid in the payment request. The payment server 30 feeds back deduction success information corresponding to the deduction processing to the first terminal 10, the second terminal 20 and the scanning device 40.

Details are described below. It needs to be noted that the order of describing the following embodiments is not defined as a preferred order of the embodiments.

It will be appreciated that in the particular embodiments of the present disclosure, relevant data such as the identity information and basic portrait information of a user (the second terminal user or the first terminal user) are involved. When the foregoing embodiments of the present disclosure are applied to particular products or technologies, allowance or agreement of the user is required, and the collection, use and processing of the relevant data need to follow laws, regulations and standards of related countries and regions.

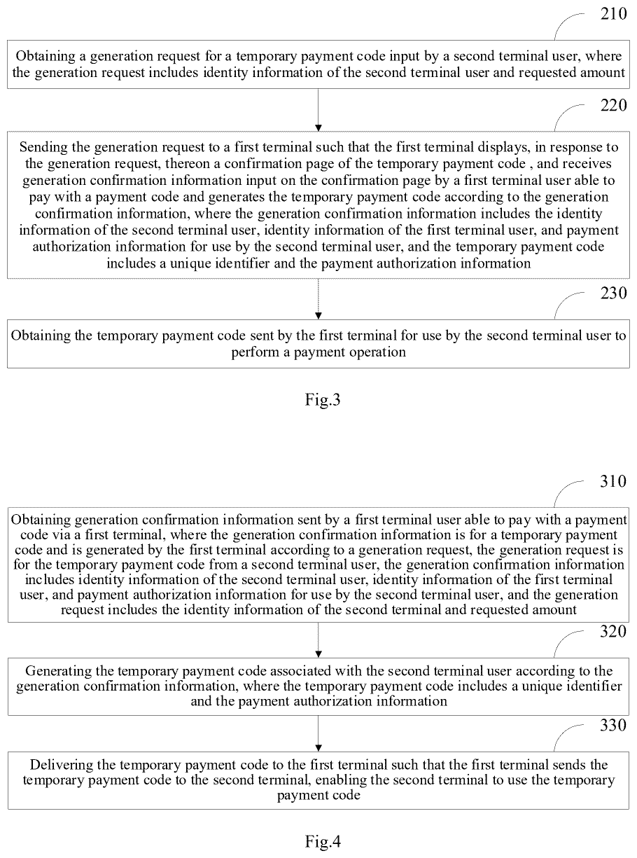

With reference to FIG. 2, FIG. 2 is a flowchart of a payment code generation method provided by an embodiment of the present disclosure. The method can be applied to the first terminal 10 in the payment system shown in FIG. 1. The method includes, but is not limited to, the following steps 110 to 130.
Step 110, displaying, in response to a generation request for a temporary payment code from a second terminal, a confirmation page of the temporary payment code on a first terminal, where the generation request includes identity information of a second terminal user and requested amount.
Step 120, receiving generation confirmation information input on the confirmation page by a first terminal user able to pay with a payment code, where the generation confirmation information includes the identity information of the second terminal user, identity information of the first terminal user, and payment authorization information for use by the second terminal user.
Step 130, generating the temporary payment code according to the generation confirmation information, and sending the temporary payment code to the second terminal so that the second terminal can use the temporary payment code, where the temporary payment code includes a unique identifier and the payment authorization information.

In step 110, the first terminal 10 (a device having the payment functionality such as a smart phone or a tablet computer) first receives the generation request for a temporary payment code from the second terminal user unable to pay with a payment code (via the second terminal 20, another mobile phone). The generation request is sent from the second terminal 20 in a certain communication manner (e.g., Bluetooth, Wi-Fi Direct, NFC, or an instant messaging application). The generation request includes the identity information of the second terminal user (e.g., name, mobile phone number, ID number, or specific user ID) and the requested amount, where the identity information of the second terminal user has been encrypted or masked. Moreover, the second terminal user may also inform the first terminal user able to pay with a payment code of the amount to be paid in a certain manner (e.g., face to face, or instant messaging software).

When the first terminal 10 receives the generation request for a temporary payment code, the first terminal 10 displays the confirmation page of the temporary payment code. The confirmation page not only presents the requested amount, but also can present part of the identity information of the second terminal user (e.g., nickname, or avatar to accord with the privacy protection policy), so that the first terminal user confirms whether or not to pay for this request. The confirmation page may also present an authorization information editing interface for the first terminal user to input the payment authorization information for use by the second terminal user.

In step 120, the first terminal user (i.e., the user able to pay with a payment code) needs to input the generation confirmation information on the confirmation page. The information generally includes: the identity information of the second terminal user, which may be part or all of the information for reconfirmation of the transactional object; the identity information of the first terminal user, which, generally, is filled in automatically for verifying the identity and the permission of the first terminal user; and the payment authorization information, which is a specific instruction for the first terminal user to agree with paying and may include authorized amount, an authorized mode of payment (e.g., remaining balance, or bank card), a period of validity of authorization, an authorization object, etc.

After confirming that all the information is correct, the first terminal user may input corresponding confirmation information (e.g., a password, or biometric information) to complete the confirmation process.

The first terminal user able to pay with a payment code operates on the first terminal 10 to select the functionality of generating a temporary payment code and input or confirm the identity information of the second terminal user and the payment authorization information for use by the second terminal user (e.g., one or more of the authorized amount, the period of validity of authorization, the authorization object for the second terminal user, authorized use times, an authorized use position range, etc.). The generation confirmation information is constituted according to the identity information of the second terminal user and the requested amount in the generation request together with the identity information of the first terminal user (which is generally obtained automatically, such as the information of the currently logged-in payment account) and the payment authorization information confirmed by the first terminal user. The first terminal 10 packages the information into complete generation confirmation information for sending to the payment server 30.

In step 130, the system generates the temporary payment code according to the generation confirmation information input by the first terminal user. The temporary payment code is unique and includes the unique identifier for identifying the transaction and the payment authorization information. The unique identifier ensures that each payment code is unique so as to prevent reuse or fraudulent conduct. The payment authorization information includes one or more of the authorized amounts, the period of validity of authorization, the authorization object for the second terminal user, the authorized use times, the authorized use position range, etc., ensuring that the second terminal 20 can perform payment correctly. Once the temporary payment code is generated, the first terminal 10 sends the temporary payment code to the second terminal 20. The second terminal user may use the temporary payment code to complete payment in a specified time range. Since the payment code includes the payment authorization information, the second terminal 20 is not required to input complex payment information again and present the temporary payment code to the merchant or the payment system so that the payment process can be completed.

In some embodiments, the second terminal user is a user unable to pay with a payment code.

For example, when the second terminal user is unable to pay with a payment code, the second terminal user cannot directly generate or use own payment code for payment. This may be due to various reasons, such as their devices used do not support the related payment technology or their accounts are not enabled with the payment function with a payment code. Although the second terminal user cannot generate own payment code, the second terminal user still can trigger the whole transaction process by sending the generation request for a temporary payment code to the first terminal.

In some embodiments, the generating the temporary payment code according to the generation confirmation information and sending the temporary payment code to the second terminal includes: sending the generation confirmation information to the payment server so that the payment server generates the temporary payment code associated with the second terminal user according to the generation confirmation information, where the temporary payment code includes the unique identifier and the payment authorization information; and obtaining the temporary payment code delivered by the payment server, and sending the temporary payment code to the second terminal so that the second terminal can perform the payment operation using the temporary payment code.

In step 130, the first terminal 10 sends the generation confirmation information for the temporary payment code to the payment server 30 over a network (e.g., Internet, or a mobile communication network). In this process, the first terminal 10 may encrypt the transmitted data using a safe communication protocol (e.g., HTTPS or TLS), thereby preventing the information form being stolen or tampered in the transmission process. The generation confirmation information includes all the key information mentioned in step 120, ensuring that the payment server 30 can accurately understand the demand of the second terminal user and generate hereby a suitable temporary payment code. Before sending the request, the first terminal 10 may perform some basic verification work, such as checking whether the network connection is stable and whether the balance of the payment account is enough, so as to ensure that the subsequent process is carried out smoothly.

After receiving the generation confirmation information, the payment server 30 performs a series of security and validity verifications to ensure the authenticity and validity of the generation confirmation information. These verification steps may include: verifying whether the identity information of the second terminal user matches that of the first terminal user, whether the payment authorization information is valid, whether the requested amount is in a reasonable range, etc. Once the payment server 30 successfully verifies the authenticity and validity of the generation confirmation information and successfully generates the temporary payment code associated with the second terminal user, the payment server 30 delivers the temporary payment code to the first terminal 10 over the network.

The first terminal 10 then receives the temporary payment code delivered by the payment server 30. The temporary payment code is a QR code or encrypted character string including the unique identifier and the payment authorization information for identifying the specific payment transaction.

After receiving the temporary payment code, the first terminal 10 may locally save it, or may present it on the user interface in a suitable manner (e.g., directly showing a QR code picture), and prompt the first terminal user or the second terminal user to do next operation. Moreover, the first terminal 10 further provides the functionality of sending the temporary payment code to the second terminal 20, and may send the temporary payment code to the second terminal 20 in a certain manner (e.g., showing a QR code, or generating an encrypted link) so that the second terminal user can obtain the temporary payment code via the second terminal 20 conveniently and perform the payment operation. The manner of sending may be sending a screenshot via instant messaging software, direct transmission via Bluetooth or NFC technology, or generating an encrypted link for the second terminal user to access via a browser, etc. No matter what manner is adopted, the security and privacy of the payment code in the transmission process should be ensured.

After the completion of sending the payment code, the first terminal 10 may record the operation log of the sending for subsequent query or auditing. Moreover, the first terminal 10 may also continuously monitor the payment result so as to provide an instant feedback to the first terminal user and the second terminal user after the payment is completed.

After receiving the temporary payment code sent by the first terminal 10 via the second terminal 20, the second terminal user may present it to the scanning device 40 (e.g., a merchant's cashier system, a self-checkout machine, or the second terminal 20 itself) via the second terminal 20 for payment. After scanning the temporary payment code, the scanning device 40 generates the payment request including the payment request time, the amount to be paid, the unique identifier and the payment authorization information corresponding to the temporary payment code, and sends the payment request to the payment server 30 for deduction processing for payment.

In the payment process, the first terminal 10 is responsible not only for receiving the generation request for a temporary payment code from the second terminal user and generating and sending the generation confirmation information for the temporary payment code to the payment server, but also for receiving the temporary payment code delivered by the payment server and sending it to the second terminal user, thereby facilitating the payment interaction between the second terminal user and the first terminal user.

In some embodiments, the step of receiving the generation confirmation information input on the confirmation page by the first terminal user able to pay with a payment code includes: obtaining the payment authorization information for use by the second terminal user that is input by the first terminal user based on an authorization information editing interface displayed on the confirmation page, where the payment authorization information includes at least authorized amount, a period of validity of authorization, and an authorization object for the second terminal user, and the authorized amount is greater than or equal to the requested amount; and generating, by the first terminal, the generation confirmation information for a temporary payment code according to the identity information of the second terminal user, the identity information of the first terminal user, and the payment authorization information.

For example, the first terminal 10 (e.g., a device having the payment functionality such as a smart phone or a tablet computer) performs the following process to generate the generation confirmation information for a temporary payment code according to the generation request for a temporary payment code from the second terminal user (e.g., user B) unable to pay with a temporary payment code.
(1) The authorization information editing interface is presented: when the first terminal 10 (the first terminal user, e.g., user A) receives the generation request for a temporary payment code sent from the second terminal user (e.g., user B) via the second terminal 20, the first terminal 10 first presents the confirmation page of the temporary payment code and displays the authorization information editing interface on the confirmation page. The interface includes necessary input field and instructions to ensure that the first terminal user can accurately fill in the information needed. The interface allows the first terminal user (user A) to self-define and input a series of payment authorization information which will be used for limiting and defining the use range and conditions of temporary payment codes.
(2) The payment authorization information is obtained: the first terminal user (user A) inputs the required payment authorization information on the authorization information editing interface. The payment authorization information includes at least:
Authorized amount: maximum amount that the first terminal user is willing to authorize the second terminal user (user B) to use, which should be greater than or equal to the payment amount requested by the second terminal user.
A period of validity of authorization: a valid time range of the temporary payment code, beyond which the temporary payment code will be invalid.

An authorization object for the second terminal user, which explicitly specifies that the temporary payment code can only be used by the specific second terminal user (user B) so as to enhance the security.

After obtaining such information, the first terminal 10 stores the information as the payment authorization information.
(3) The generation confirmation information is generated: after obtaining the complete payment authorization information, the first terminal 10 uses the identity information of the second terminal user (such as user ID and mobile phone number, which may be obtained in advance in a certain manner or input on the scene), the identity information of the first terminal user, and the payment authorization information together to form the generation confirmation information for a temporary payment code. The generation confirmation information will be sent to the payment server 30 so that a unique temporary payment code is created in a back-end payment system and allocated to the second terminal user (user B).

By the above process, the first terminal 10 not only meets the demand of the second terminal user unable to pay with a payment code, but also ensures the flexibility and security of payment via the authorization information editing interface. Moreover, by specifying the authorization object and the period of validity, the potential risk is further reduced.

In some embodiments, the payment authorization information further includes the authorized use times and/or the authorized use position range.

Upon receiving a request for obtaining a temporary payment code from the second terminal user (user B), the first terminal 10 will present a detailed authorization information editing interface. The interface provides, in addition to basic information such as the authorized amount, the period of validity of authorization and the authorization object for the second terminal user, additional options allowing the first terminal user (user A) to set the authorized use times and/or the authorized use position range.

The first terminal user (user A) inputs the required payment authorization information on the authorization information editing interface. Such information includes, but is not limited to:
The authorized amount: the maximum amount that the first terminal user is willing to authorize the second terminal user to use.
The period of validity of authorization: the valid time range of the temporary payment code.

The authorization object for the second terminal user, specifying the user of the temporary payment code.

The authorized use times, explicitly limiting the number of times that the temporary payment code can be used. This is helpful for preventing the temporary payment code from being abused, especially in a scenario of a large amount or a high security requirement.

The authorized use position range: defining which geographical locations or regions the temporary payment code can be used in. This may be implemented by GPS positioning, a list of specific merchants, or in other ways, to improve the security and accuracy of payment.

After obtaining the complete payment authorization information including the authorized use times and/or the authorized use position range, the first terminal 10 uses the identity information of the second terminal user and the identity information of the first terminal user together with such payment authorization information to form detailed generation confirmation information for a temporary payment code. The generation confirmation information will be sent to the payment server 30, and the payment server 30 will processes this additional authorization information to ensure that all set conditions are met in the payment process.

With the payment authorization information including the authorized use times and/or the authorized use position range, the first terminal user can control the use of the temporary payment code more accurately. The security and efficiency of payment are further improved. The method can be applied to deal with transactions with large amounts or limit the payment range or meet the payment demands in specific scenarios.

In some embodiments, the method further includes: obtaining deduction success information corresponding to deduction processing fed back by the payment server, where the deduction processing is implemented by the payment server performing the following operations: the payment server obtains a payment request that is generated by scanning the temporary payment code and sent by the scanning device, the payment request including the payment request time, the amount to be paid, the unique identifier and the payment authorization information corresponding to the temporary payment code; and upon determining that the payment request is valid according to the unique identifier and the payment authorization information, the payment server performs the deduction processing on a payment account corresponding to the first terminal user according to the amount to be paid in the payment request.

For example, after completing the sending of the temporary payment code, the first terminal 10 continuously monitors the feedback from the payment server 30. Especially after the payment server 30 completes the deduction processing, it sends the deduction success information to the first terminal 10 and/or the second terminal 20.

After verifying that the payment request is valid and performing the deduction operation, the payment server 30 records transaction information and generates the feedback of the deduction success information. The deduction success information includes key information of the transaction, such as a deduction time, an amount deducted, and a transaction status. The payment server 30 sends the deduction success information to the first terminal over a network.

After receiving the deduction success information, the first terminal 10 updates its user interface, displays the status of completed payment, and provides an instant notification to the first terminal user. This is helpful for enhancing the user experience and enables the first terminal user to know the transaction status in real time.

Although the deduction success information is mainly sent to the second terminal user by the payment server 30 (via the second terminal 20), in some embodiments, the first terminal 10 may also selectively inform the payment status of the second terminal user. For example, upon receiving the deduction success information, the first terminal 10 may select to send a notification of completed payment to the second terminal user via the second terminal 20 by means of instant messaging software, a short message, or in other communication ways. The notification may include brief information of the transaction, such as the deducted amount and the transaction time. The second terminal user is directly notified of the payment status via the first terminal 10, and the transparency and credibility of the transaction can be further enhanced. Meanwhile, this also facilitates the communication between the first terminal user and the second terminal user.

For the convenience of subsequent query and auditing, the first terminal 10 may also record the transaction log. After completing the sending of the temporary payment code and receiving the deduction success information, the first terminal 10 records the relevant information of this transaction in the local storage, such as transaction time, transaction amount, the identity information of the second terminal user and the first terminal user, and the unique identifier of the temporary payment code. The recording of the transaction log is helpful for the first terminal user to check own transaction history at any time, ensuring the accuracy and security of the transaction. Meanwhile, this also provides strong supporting evidence for possible dispute settlement.

In the payment process, the first terminal 10 not only is responsible for generating and sending the temporary payment code, but also participates in key steps such as receiving the deduction success information, notifying the second terminal user of the payment status and recording the transaction log, thereby ensuring that the whole payment process is carried out smoothly.

In some embodiments, before obtaining the deduction success information corresponding to the deduction processing fed back by the payment server, the method further includes: obtaining a deduction verification request sent by the payment server, where the deduction verification request is used for the first terminal user to perform deduction verification; and generating deduction verification information in response to the deduction verification request in a preset time period, and sending the deduction verification information to the payment server so that the payment server performs the deduction processing on the payment account corresponding to the first terminal user according to the deduction verification information and the amount to be paid in the payment request.

In the payment process, to guarantee the fund security of the first terminal user and enhance the payment experience, the payment system adds the deduction verification step on the first terminal 10. This step occurs after the payment server 30 receives the payment request and finishes preliminary verification, but before the deduction operation is actually performed.

Firstly, the payment server 30 sends a deduction verification request to the first terminal 10. The request usually includes key information about the payment request, such as a merchant name, a commodity and service description, and the amount to be paid. Such information is presented to the first terminal user in a clear and comprehensible manner so that the first terminal user can accurately know the details of the transaction which is about to be conducted.

When the first terminal 10 receives the deduction verification request, a verification interface or notification pops up immediately to prompt the first terminal user to perform deduction verification. The interface or notification presents the key information in the request and queries whether the first terminal user agrees with this payment. The first terminal user needs to respond to the deduction verification request through identity verification in a preset time period (such as several seconds to several minutes). The identity verification may be implemented in a plurality of ways, such as inputting a password, fingerprint verification, and using face recognition. These ways are selected depending on the security strategy of the payment system and the personal preference and settings of the first terminal user. Once the first terminal user successfully passes the identity verification, the first terminal 10 generates the deduction verification information. This information is a signal encrypted or processed with a specific algorithm, indicating that the first terminal user has agreed with this payment. The first terminal 10 then sends the deduction verification information to the payment server 30.

After receiving the deduction verification information, the payment server 30 performs verification immediately. If the verification is successful, i.e., it is determined that the deduction verification information is valid and comes from the legal first terminal user, the payment server 30 performs the deduction operation. The deduction operation refers to deduct the corresponding amount from the payment account corresponding to the first terminal user according to the amount to be paid in the payment request.

After the deduction is successful, the payment server 30 generates deduction success information and sends it to the first terminal 10 via a network. After receiving the information, the first terminal 10 updates a payment interface or pops up a notification immediately to inform the first terminal user of the payment having been completed successfully.

By this deduction verification process, the payment system not only improves the security of the payment process and reduces the risks of unauthorized payments, but also enhances the user experience with a reasonable preset time period and in diversified identity verification ways. The first terminal user can actively participate in the verification process to ensure that each payment has been expressly agreed by the first terminal user, thereby effectively guaranteeing the security of the payment process and the user's fund security.

In the deduction verification process, the first terminal 10 not only receives and presents the deduction verification request, but also is responsible for the identity verification and the generation of the deduction verification information and for sending the deduction verification information to the payment server 30 to complete the payment process. This process takes the first terminal user's demands for security and convenience into full consideration and provides powerful guarantee for efficient operation of the payment system.

In some embodiments, the method further includes: sending to the payment server a modification request made by the first terminal user for the generated temporary payment code so that the payment server updates the temporary payment code according to the modification request when determining that the generated temporary payment code is not used; and obtaining the updated temporary payment code delivered by the payment server, and sending the updated temporary payment code to the second terminal.

In order to improve the flexibility and security of payment, the first terminal user might need to modify the generated temporary payment code. For example, the first terminal user may find that the period of validity of the original payment code is too short or the payment limit does not meet the requirement of the current transaction. For example, the first terminal user initiates a request to modify the temporary payment code via a payment app or a relevant interface on the first terminal 10, and input or select a content needing to be modified, such as a new authorized amount, a new period of validity of authorization, or a new payment account. The first terminal 10 generates, according to the modified content input by the user, a modification request including the modified content, and sends the request to the payment server. The identifier of the temporary payment code (e.g., a QR code number or a payment ID) to be modified and the new payment authorization information (e.g., a new authorized amount, a new period of validity of authorization, or a new authorization object) should be specified in the modification request.

The first terminal 10 sends the modification request to the payment server 30. After receiving the modification request, the payment server 30 first checks whether the specified temporary payment code has not been used yet. This is to avoid allowing for modification when the transaction has taken place, which may lead to payment dispute or security problems. If the payment server 30 confirms that the temporary payment code is not used, it updates the temporary payment code according to the modified content in the modification request. The modified content may include operations such as adjusting the authorized amount, the period of validity of authorization, associating a new payment account, and associating an authorization object. After completing the modification, the payment server 30 delivers the updated temporary payment code to the first terminal 10. This updated temporary payment code includes the latest payment condition and the unique identifier, ensuring the accuracy and security of the payment process.

After obtaining the updated temporary payment code, the first terminal 10 needs to send the payment code to the second terminal 20. For example, after receiving the updated temporary payment code, the first terminal 10 presents, via the payment app or the relevant interface, the payment code to the first terminal user for viewing. At the same time, a sending option is provided, allowing the first terminal user to send the payment code to other devices or platforms. After the first terminal user selects the sending option, the payment code may be sent to the second terminal 20 in multiple ways such as via Bluetooth, Wi-Fi Direct, QR code transmission, and social apps. The specific sending way depends on the hardware support of the first terminal 10 and the operation habit of the user.

After receiving the payment code, the second terminal 20 may verify it to ensure its validity and accuracy. This typically includes checking the unique identifier of the payment code, the payment condition, and whether the payment code has expired, etc. After the verification is successful, the second terminal 20 may start to perform the payment process.

The first terminal 10 is not only capable of receiving and responding to the deduction verification request from the payment server 30 in the payment process, but also capable of actively initiating the modification request for the temporary payment code, and sending the updated payment code to the second terminal 20 after obtaining it. This process further enhances the flexibility and security of payment and the user experience.

In some embodiments, the method further includes: sending to the payment server a cancel request made by the first terminal user for the generated temporary payment code so that the payment server cancels the temporary payment code according to the cancel request when determining that the generated temporary payment code is not used; and obtaining a cancel notification for the temporary payment code delivered by the payment server, and sending the cancel notification to the second terminal.

In order to enhance the flexibility and security of the payment process, the first terminal 10 provides the function of canceling the generated temporary payment code. When the first terminal user decides not to use the generated temporary payment code (e.g., due to reasons such as the payment plan being altered and the information of the payee being incorrect), the cancel request may be sent to the payment server 30 via the first terminal 10.

For example, the first terminal user initiates the request to cancel the temporary payment code via the payment app or the relevant interface on the first terminal 10, and confirms a cancel operation. The first terminal 10 generates a cancel request according to the user's operation and sends the cancel request to the payment server 30. The cancel request should include enough information to uniquely identify the temporary payment code to be canceled.

After receiving the cancel request sent by the first terminal 10, the payment server 30 first verifies the validity of the request and checks whether the generated temporary payment code is in an unused status. For example, the status of the generated temporary payment code is queried in the database to confirm whether the generated temporary payment code is not used. If the temporary payment code has been used, it cannot be canceled, and corresponding error information is returned to the first terminal 10. If the verification is successful and the temporary payment code is not used, the payment server 30 will perform the cancel operation, label the temporary payment code as canceled, and record the reason and time of canceling.

After completing the canceling of the temporary payment code, the payment server 30 delivers the cancel notification to the first terminal 10 so that the first terminal user knows the result of the cancel operation. For example, the payment server 30 generates the cancel notification including a cancel result, which may include information such as cancel success, cancel failure, and reasons thereof. The cancel notification is then sent to the first terminal 10, ensuring that the first terminal user can obtain the feedback information of the cancel operation in time.

After receiving the cancel notification, the first terminal 10 may select to send the cancel notification to the second terminal 20 (the terminal of the second terminal user) or other interested parties to ensure that the payee also knows the change of the payment status.

The first terminal 10 may present the content of the cancel notification on the payment app or the relevant interface.

The first terminal 10 provides a sending function, allowing the first terminal user to send the cancel notification to the second terminal 20 or other devices in multiple ways such as scanning a code, copying a link, sending a short message, or sending to a social media. Sending the cancel notification is helpful for avoiding potential payment misunderstanding or disputes.

The first terminal 10 not only supports the generation and sending of a temporary payment code, but also can cancel the temporary payment code when necessary to ensure the flexibility and security of the payment process. The cancel function is of great important in terms of reducing payment mistakes, preventing payment risks, etc.

All the technical solutions described above can be arbitrarily combined to form optional embodiments of the present disclosure, which are not described one by one herein.

According to the embodiments of the present disclosure, the first terminal displays thereon the confirmation page of the temporary payment code in response to the generation request for a temporary payment code from the second terminal, where the generation request includes the identity information of the second terminal user and the requested amount. The generation confirmation information input on the confirmation page by the first terminal user able to pay with a payment code is input, where the generation confirmation information includes the identity information of the second terminal user, the identity information of the first terminal user, and the payment authorization information for use by the second terminal user. The temporary payment code is generated according to the generation confirmation information, and sent to the second terminal so that the second terminal can use the temporary payment code, where the temporary payment code includes the unique identifier and the payment authorization information. According to the embodiments of the present disclosure, by allowing the first terminal user able to pay with a payment code to generate the temporary payment code for the second terminal user, the flexibility and the application range of the manner of payment are expanded. The problem that the second terminal user cannot make payments directly using payment codes due to technical or device restrictions is solved. The payment process is simplified. The convenience of payment is improved. The generated temporary payment code includes the unique identifier and the payment authorization information, ensuring the authenticity, validity and security of payment.

With reference to FIG. 3, FIG. 3 is a flowchart of a payment method provided by an embodiment of the present disclosure. The method can be applied to the second terminal 20 in the payment system shown in FIG. 1. The method includes, but is not limited to, the following steps 210 to 230.
Step 210, obtaining a generation request for a temporary payment code input by a second terminal user, where the generation request includes identity information of the second terminal user and requested amount.
Step 220, sending the generation request to a first terminal so that the first terminal displays, in response to the generation request, thereon a confirmation page of the temporary payment code, and receives generation confirmation information input on the confirmation page by a first terminal user able to pay with a payment code and generates the temporary payment code according to the generation confirmation information, where the generation confirmation information includes the identity information of the second terminal user, identity information of the first terminal user, and payment authorization information for use by the second terminal user, and the temporary payment code includes a unique identifier and the payment authorization information.
Step 230, obtaining the temporary payment code sent by the first terminal for use by the second terminal user to perform a payment operation.

In step 210, the second terminal 20 serves as the starting point of interaction between the second terminal user and the temporary payment code, and receives the generation request for a temporary payment code input by the second terminal user unable to pay with a payment code (e.g., user B).

The second terminal user inputs the generation request for a temporary payment code via a payment app, a web page or other interfaces on the second terminal 20. The generation request needs to include the identity information of the second terminal user (e.g., a mobile phone number, an ID number, or an account ID) and the requested amount.

The second terminal 20 may preliminarily verify the input identity information, ensuring the accuracy and validity of the information. This step may include comparing with pre-stored information, sending a verification code for verification, etc. After the verification is successful, the second terminal 20 may generate a generation request according to the input from the second terminal user. The generation request includes necessary information such as the identity information of the second terminal user and the requested amount.

In step 220, after the verification is successful, the second terminal 20 sends the generation request for a temporary payment code to the first terminal 10 (e.g., the terminal of the first terminal user able to pay with a payment code). The first terminal 10 displays thereon the confirmation page of the temporary payment code in response to the generation request so that the first terminal 10 receives the generation confirmation information input on the confirmation page by the first terminal user able to pay with a payment code and generates the temporary payment code associated with the second terminal user according to the generation confirmation information.

In particular, the second terminal 20 sends the generation request to the first terminal 10 via a network (e.g., Wi-Fi or a mobile network). After receiving the generation request, the first terminal 10 parses the request content to obtain information such as the identity information of the second terminal user and the requested amount. Then, the first terminal 10 displays thereon the confirmation page of the temporary payment code in response to the generation request so that the first terminal 10 receives the generation confirmation information input on the confirmation page by the first terminal user able to pay with a payment code. The generation confirmation information includes the identity information of the second terminal user, the identity information of the first terminal user, and the payment authorization information. The first terminal 10 sends the generation confirmation information to the payment server 30. The payment server 30 verifies the identities of the first terminal user and the second terminal user according to the content of the generation confirmation information, and generates a temporary payment code. The temporary payment code includes the unique identifier and the payment authorization information for subsequent payment operation The payment server 30 delivers the generated temporary payment code to the first terminal 10. After receiving the generated temporary payment code, the first terminal 10 may perform further processing (e.g., saving or presenting) thereon.

In step 230, the first terminal 10 sends the received temporary payment code to the second terminal 20 so that the second terminal user (user B) obtains the temporary payment code via the second terminal 20 and performs the payment operation.

In particular, the first terminal 10 presents the temporary payment code on the local device, which may be in the form of a QR code or in other identifiable forms. The first terminal 10 provides the sending function, allowing the user to send the temporary payment code to the second terminal 20 in multiple ways such as scanning the code, copying a link, or sending a short message.

The second terminal 20 obtains the temporary payment code in a corresponding receiving manner (e.g., scanning the code, or receiving the short message), and presents it to the second terminal user (user B). The second terminal user uses the temporary payment code by scanning the code or in other ways to conduct the payment operation.

This process ensures safe and convenient payment operation with the temporary payment code between the second terminal user unable to pay with a payment code and the first terminal user able to pay with a payment code. Meanwhile, the flexibility and security of payment are also improved.

In some embodiments, obtaining the generation request for a temporary payment code input by the second terminal user includes: presenting a request editing interface for a temporary payment code; and obtaining the generation request for a temporary payment code input by the second terminal user based on the request editing interface, where the generation request includes the identity information of the second terminal user and the requested amount.

In order to collect the inputs from the second terminal user unable to pay with a payment code (e.g., user B) more intuitively and conveniently, the second terminal 2 presents a dedicated request editing interface for a temporary payment code.

For example, the second terminal 20 may first present a clear, easy-to-use request editing interface on the user interface thereof. This interface should include a necessary input box and prompt message so as to guide the second terminal user to correctly input the relevant information.

For example, the input box is set as follows:
An identity information input box: one or more input boxes are provided for the second terminal user to input the identity information of the second terminal user. These information may include a mobile phone number, an ID number, an account ID, etc., depending on the verification requirement of the system and the privacy policy.
A requested amount input box: one figure input box is provided, allowing the second terminal user to input the desired amount to be paid. In order to enhance the user experience, the check of the amount format may be added, ensuring that a valid amount is input.

For example, an explicit prompt message may also be provided beside or below the input box to inform the second terminal user of the content needing to be input, the format requirement, and the possible limiting condition.

The second terminal user then fills in own identity information and the requested amount in the corresponding input boxes according to the guidance of the request editing interface. After the completion of inputting, some additional operations may also be performed (e.g., tapping on the button “confirm”) to submit the request.

For example, after the second terminal user submits the input, the second terminal 20 may further preliminarily verify the input data. This includes checking whether the identity information is complete, whether the requested amount is within a reasonable range, etc. If the verification is failed, a corresponding error prompt will be given, requiring the second terminal user to input again. After the verification is successful, the second terminal 20 will generate a formal generation request according to the input from the second terminal user. The generation request includes key information such as the identity information of the second terminal user and the requested amount, and possible other necessary parameters (such as a request timestamp and a source of the request).

The generated generation request will be stored in the local database or the internal memory of the second terminal 20 and be ready for sending to the first terminal 10 (e.g., the terminal of the first terminal user A able to pay with a payment code). According to a specific implementation of the system, this sending process may be carried out immediately or after certain conditions (e.g., confirmation by the user, or network connection) are met.

By the above steps, the second terminal 20 can effectively obtain the generation request for a temporary payment code from the second terminal user unable to pay with a payment code, providing necessary information basis for the subsequent generation and sending processes of the temporary payment code.

In some embodiments, the method further includes: displaying a candidate first terminal user list on the request editing interface, where the candidate first terminal user list is configured for the second terminal user to select a first terminal user matching the temporary payment code from the candidate first terminal user list; and the generation request further includes the identity information of the first terminal user.

In order to enhance the user experience and ensure the flexibility of payment, the second terminal 20 not only provides input options of the identity information and the requested amount but also presents a candidate first terminal user list on the request editing interface.

For example, when loading the request editing interface, the second terminal 20 generates a candidate first terminal user list according to first terminal user data within the system. The candidate first terminal user list may be generated automatically based on historical transaction records, frequent contacts, payment account bound relationships, etc., of the second terminal user.

For example, the candidate first terminal user list should include the necessary information of each candidate first terminal user, such as name (or nickname), account ID, payment mode identifier (such as Alipay or WeChat Pay), possible credit assessment or recommendation grade, intimate degree, and interaction frequency. This information may help the second terminal user with rapidly knowing and selecting the matched first terminal user.

The candidate first terminal user list may be presented on the request editing interface in the form of a pull-down list, a scrollable list, a grid layout, or the like. In order to improve the readability, there should be appropriate spacing and separation line between list items, and key information should be highlighted (e.g., bold or highlighting).

In order to improve the selection efficiency, the second terminal 20 may further provide selection and ordering functions. The second terminal user may select and order the candidate first terminal users according to conditions such as a mode of payment, a payment limit and credit assessment so as to find the matched first terminal user rapidly.

The second terminal user may select one or more first terminal users according to own requirement and preference after browsing the candidate first terminal user list. This is typically completed by tapping on a selection box or button beside a list item or other interactive operations.

After selecting the first terminal user, the second terminal updates the interface in real time and displays the information of the selected first terminal user, and may include the information of the first terminal user in the generation request. Meanwhile, in order to ensure the accuracy of selection, the second terminal 20 may also provide a confirmation prompt, requiring the second terminal user to reconfirm the selected first terminal user.

After the second terminal user completes the selection of the first terminal user, the second terminal 20 generates a final generation request according to the user's input and selection. The generation request includes not only the identity information of the second terminal user and the requested amount, but also the identity information of the first terminal user (e.g., the account ID).

After generating the generation request, the second terminal 20 may perform necessary data verification, ensuring the accuracy and integrity of all the information. After the verification is successful, the second terminal 20 sends the generation request to the first terminal 10 (e.g., the terminal of the selected first terminal user) so as to generate the corresponding temporary payment code.

By the above steps, the second terminal 20 presents the candidate first terminal user list on the request editing interface, thereby not only improving the selection flexibility of the user but also ensuring the accuracy and security of payment. Meanwhile, this also provides more complete information basis for the subsequent temporary payment code generation and sending processes.

In some embodiments, the method further includes: generating the candidate first terminal user list according to intimate degrees of the second terminal user with candidate first terminal users; or generating the candidate first terminal user list according to interaction frequencies of the second terminal user with candidate first terminal users.

In order to further enhance the user experience and the convenience of payment, when generating the candidate first terminal user list, the second terminal 20 takes the specific relationships and the frequencies of interaction between the second terminal user and the candidate first terminal users into account.

For example, the candidate first terminal user list is generated based on the intimate degree. The intimate degree may be derived based on a plurality of factors, such as the times of historical transactions of both parties, transaction amounts, communication records (such as short messages, voice calls, and video calls), social media interactions (likes, comments, private messages, etc.), and basic portrait information such as user-defined groups or labels. An algorithm is built in the second terminal 20 to obtain a value or grade representing an intimate degree through comprehensive assessment with respect to the above factors of the second terminal user and each candidate first terminal user. This algorithm may be weighted averaging, machine learning model, or other complex data analysis methods. The second terminal 20 may order the candidate first terminal users in a descending sequence (or an ascending sequence, depending on the user's demand) according to the calculated intimate degrees, and generates the final candidate first terminal user list. Thus, the second terminal user can see the first terminal user in the closest relationship with the second terminal user on the top of the list.

For example, the candidate first terminal user list is generated based on the interaction frequency. The second terminal 20 records the interaction frequency of the second terminal user and each candidate first terminal user in a historical time period. Here, the interaction includes, but is not limited to, interaction between users in any form of transaction, communication, interaction via a social media, etc. For example, the historical time period may be set according to an actual requirement, e.g., a time range of the last week, one month, three months or longer. The characteristics of a payment scenario and user demands should be considered in the selection of the time period. Then, based on the recorded interaction frequencies, the second terminal 20 may order the candidate first terminal users in a descending sequence (or an ascending sequence) according to the interaction frequencies, and generates the candidate first terminal user list. Thus, the second terminal user can intuitively see the first terminal users who frequently interact with the second terminal user recently on the list.

In practical application, the second terminal 20 may generate the candidate first terminal user list by taking two factors (i.e., intimate degree and interaction frequency) into full consideration. For example, the candidate first terminal users may be preliminarily selected and ordered first according to the intimate degrees, and then the first terminal users at the same intimate degree are further ordered according to the interaction frequencies. This can ensure the accuracy and relevance of the list and improve the user selection efficiency.

The candidate first terminal user list generated in the above manner can not only better meet the actual demand and conform to the preference of the second terminal user, but also improve the convenience and security of payment to a certain extent. Meanwhile, this also provides more personalized services and room for optimization for the payment platform.

In some embodiments, the method further includes: presenting the temporary payment code to a scanning device so that the scanning device scans the temporary payment code to generate a payment request and sends the payment request to the payment server, where the payment request includes payment request time, amount to be paid, the unique identifier and the payment authorization information corresponding to the temporary payment code; and obtaining deduction success information corresponding to deduction processing fed back by the payment server, where the deduction processing refers to that, upon determining that the payment request is valid according to the unique identifier and the payment authorization information, the payment server performs the deduction processing on a payment account corresponding to the first terminal user according to the amount to be paid in the payment request.

The payment system includes the scanning device 40 (e.g., a POS machine, a self-checkout terminal, or a camera of a mobile device) in addition to the first terminal 10 (the first terminal user), the second terminal 20 (the second terminal user) and the payment server 30. In such a payment system, the second terminal 20 plays an important role in the payment process, which not only is responsible for initiating the generation request for a temporary payment code, but also participates in the generation of the payment request and the feedback of deduction success.

For example, after successfully obtaining the temporary payment code (which is possibly sent by the first terminal 10 or directly delivered by the payment server 30 to the second terminal 20), the second terminal 20 presents the temporary payment code on the user interface thereof. This is typically a QR code or a bar code, which includes all necessary information required for payment, such as the unique identifier and the payment authorization information.

Then, the second terminal user (e.g., a consumer) or the relevant operating personnel uses the scanning device 40 to scan the temporary payment code presented on the second terminal 20. By the built-in scanning function of the scanning device 40, the information in the QR code is read and parsed, and the payment request including the payment request time, the amount to be paid, the unique identifier and the payment authorization information corresponding to the temporary payment code are generated.

After generating the payment request, the scanning device 40 sends the request to the payment server 30 via the network (e.g., Wi-Fi or the mobile network). The payment server 30 is the core processing unit of the payment system, and is responsible for verifying the validity of the payment request and performing the deduction operation.

After receiving the payment request, the payment server 30 determines the validity of the payment request according to the unique identifier and the payment authorization information therein. If the verification is successful, the payment server 30 will preforms the deduction processing on the payment account corresponding to the first terminal user according to the amount to be paid in the payment request. This process involves interaction with the bank or the payment platform where the payment account is located. After successfully completing the deduction processing, the payment server 30 generates deduction success information and feeds back the deduction success information to the second terminal 20. The ways of feedback may include sending a short message, pushing a notification, updating the payment status on the second terminal, etc.

After receiving the deduction success information, the first terminal 20 updates its user interface, displays the status of completed payment, and provides an instant notification to the second terminal user.

The second terminal 20 serves as a bridge in the payment system to connect the second terminal user, the scanning device 40, and the payment server 30. As a result, not only are the payment process simplified and the convenience of payment improved, but also the security and accuracy of the payment process are ensured. Meanwhile, by obtaining the feedback of the deduction success information, the second terminal 20 can also provide more perfect payment experience and services for users.

In some embodiments, the method further includes: receiving invalidation information of the temporary payment code after the scanning device scans the temporary payment code; generating a new generation request for a temporary payment code according to the invalidation information; sending the new generation request for a temporary payment code to the first terminal so that the first terminal displays thereon the confirmation page of the temporary payment code in response to the new generation request, and receives new generation confirmation information input on the confirmation page by the first terminal user able to pay with a payment code and generates a new temporary payment code according to the new generation confirmation information, where the new generation confirmation information includes the identity information of the second terminal user, the identity information of the first terminal user able to pay with a payment code, and new payment authorization information for use by the second terminal user, and the new temporary payment code includes a unique identifier and the new payment authorization information; and obtaining the new temporary payment code sent by the first terminal for use by the second terminal user to perform the payment operation.

In order to cope with the case where the temporary payment code might be invalid due to various reasons (e.g., expiring, misuse, or payment server malfunction), the payment system provides the function of regenerating a temporary payment code.

For example, when the scanning device 40 attempts to scan a temporary payment code to generate a payment request, if the payment server 30 detects that the temporary payment code has become invalid (e.g., the payment code has expired or has been used, or the payment server cannot verify the validity thereof), the payment server 30 sends the invalidation information of the temporary payment code to the second terminal 20 (and/or the scanning device 40).

After receiving the invalidation information, the second terminal 20 (and/or the scanning device 40) presents a corresponding prompt message on its user interface to inform the user that the payment code has become invalid and the payment operation cannot be completed.

After seeing the prompt that the payment code is invalid, the second terminal user may select to generate a new temporary payment code. To this end, the second terminal user might perform a series of operations via the second terminal 20 (e.g., a mobile phone app).

The second terminal 20 generates a new generation request for a temporary payment code according to the operation of the second terminal user. The request includes the identity information of the second terminal user, the requested amount, and possible other necessary information (such as first terminal user preference and a payment channel). Unlike the initial generation request, the new generation request might also include an identifier or parameter instructing the payment server 30 to generate a new payment code.

The second terminal 20 sends the new generation request to the first terminal 10. After receiving the new generation request, the first terminal 10 displays thereon the confirmation page of the temporary payment code in response to the new generation request so that the first terminal receives new generation confirmation information input on the confirmation page by the first terminal user able to pay with a payment code. The new generation confirmation information includes the identity information of the second terminal user, the identity information of the first terminal user able to pay with a payment code, and new payment authorization information for use by the second terminal user. The first terminal then sends the new generation confirmation information to the payment server 30.

After receiving the new generation confirmation information, the payment server 30 verifies the information in the new generation confirmation information, and generates a new temporary payment code according to this information. The new payment code includes a new unique identifier and the new payment authorization information. In case of successful generation, the payment server 30 delivers the new temporary payment code to the first terminal 10 or the second terminal 20.

After receiving the new temporary payment code, the first terminal 10 sends it to the second terminal 20. This may be implemented in multiple ways, such as scanning the code, copying a link, or sending via instant messaging software.

After receiving the new temporary payment code, the second terminal 20 presents the new temporary payment code on its user interface, and prompts the second terminal user to perform the payment operation (e.g., scanning the payment code again). After the second terminal user conducts the operation according to the prompt, the scanning device scans the new payment code and generates the new payment request, thereby finally completing the payment process.

Through this process, even though the temporary payment code is invalid due to various reasons, the second terminal user can also obtain a new payment code conveniently, thus ensuring smooth payment. This function improves the flexibility of the payment system and the user experience.

All the technical solutions described above can be arbitrarily combined to form optional embodiments of the present disclosure, which are not described one by one herein.

According to the embodiments of the present disclosure, the second terminal obtains the generation request for a temporary payment code input by the second terminal user, where the generation request includes the identity information of the second terminal user and the requested amount. The generation request is sent to the first terminal so that the first terminal displays thereon the confirmation page of the temporary payment code in response to the generation request, and receives generation confirmation information input on the confirmation page by the first terminal user able to pay with a payment code and generates the temporary payment code according to the generation confirmation information, where the generation confirmation information includes the identity information of the second terminal user, the identity information of the first terminal user, and the payment authorization information for use by the second terminal user, and the temporary payment code includes the unique identifier and the payment authorization information. The temporary payment code sent by the first terminal is obtained for use by the second terminal user to perform the payment operation. According to the embodiments of the present disclosure, by allowing the first terminal user able to pay with a payment code to generate the temporary payment code for the second terminal user, the flexibility and the application range of the mode of payment are expanded. The problem that the second terminal user cannot make payments directly using payment codes due to technical or device restrictions. The payment process is simplified. The convenience of payment is improved. The generated temporary payment code includes the unique identifier and the payment authorization information, ensuring the authenticity, validity and security of payment.

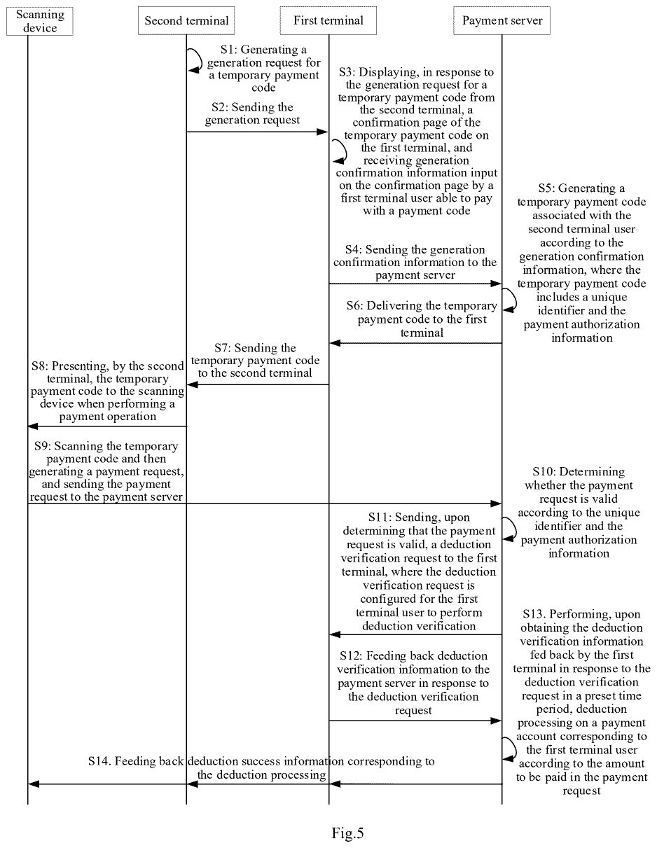

With reference to FIG. 4, FIG. 4 is another flowchart of a payment code generation method provided by an embodiment of the present disclosure. The method can be applied to payment server 30 in the payment system shown in FIG. 1. The method includes, but is not limited to, the following steps 310 to 330.
Step 310, obtaining generation confirmation information sent by a first terminal user able to pay with a payment code via a first terminal, where the generation confirmation information is for a temporary payment code and is generated by the first terminal according to a generation request, the generation request is for the temporary payment code from a second terminal user, the generation confirmation information includes identity information of the second terminal user, identity information of the first terminal user, and payment authorization information for use by the second terminal user, and the generation request includes the identity information of the second terminal and requested amount.

In step 310, the payment server 30, as the core processing unit of the entire payment process, is responsible for receiving and processing the generation confirmation information for a temporary payment code from the first terminal 10. The generation confirmation information is generated by the first terminal 10 according to the generation request previously received from the second terminal 20. The second terminal 20 is used by the second terminal user unable to pay with a payment code, and sends the generation request including the identity information of the second terminal and the requested amount to the first terminal 10. This request is that the second terminal user wishes to generate a temporary payment code via the first terminal 10 (used by the first terminal user able to pay with a payment code) so as to facilitate the subsequent payment operation. After receiving the generation request, the first terminal 10 combines its own identity information (i.e., the identity information of the first terminal user) and the payment authorization information (which might be a password, a fingerprint, or a result of a verification mode such as face recognition) input by the first terminal user into complete generation confirmation information for sending to the payment server 30. By this step, the payment server 30 indirectly receives dual information of the second terminal user and the first terminal user, ensuring the authenticity and security of the transaction.
Step 320, generating the temporary payment code associated with the second terminal user according to the generation confirmation information, where the temporary payment code includes a unique identifier and the payment authorization information.

In step 320, after receiving the generation confirmation information, the payment server 30 will perform a series of security and validity verifications. These verifications include, but are not limited to, verifying whether the identity information of the second terminal user matches that of the first terminal user, whether the payment authorization information is valid, whether the requested amount is in a reasonable range, etc. Once all the verifications are successful, the payment server 30 generates a temporary payment code closely associated with the second terminal user according to these information. The payment code has uniqueness and includes the unique identifier for identifying the current transaction and the payment authorization information for verifying the payment permission. Such a design guarantees the security of the transaction and facilitates the subsequent payment verification process.
Step 330, delivering the temporary payment code to the first terminal so that the first terminal sends the temporary payment code to the second terminal, enabling the second terminal to use the temporary payment code.

In step 330, after successfully generating the temporary payment code, the payment server 30 immediately delivers the payment code to the first terminal 10. After receiving the payment code, the first terminal 10 sends it to the second terminal 20 in a safe and convenient way (e.g., presenting via a QR code, or sending via an encrypted link). Thus, the second terminal user may view the temporary payment code via the second terminal 20 and present the payment code to the scanning device 40 when performing the payment operation. After scanning the payment code, the scanning device 40 generates the payment request including the payment request time, the amount to be paid, the unique identifier and the payment authorization information corresponding to the temporary payment code, and sends the request to the payment server 30 for final payment processing. By this step, the payment server 30 not only completes the generation and delivery of the temporary payment code, but also indirectly promotes the payment interaction between the second terminal user and the first terminal user, laying a firm foundation for subsequent payment verification and deduction processing.

In some embodiments, generating the temporary payment code associated with the second terminal user according to the generation confirmation information includes: obtaining the identity information of the second terminal user, the identity information of the first terminal user, and the payment authorization information according to the generation confirmation information, where the payment authorization information includes authorized amount, a period of validity of authorization, and an authorization object for the second terminal user, and the authorized amount is greater than or equal to the requested amount; and generating the temporary payment code associated with the second terminal user according to the identity information of the second terminal user, the identity information of the first terminal user, and the payment authorization information.

The payment server 30 first receives the generation confirmation information for a temporary payment code from the first terminal 10. The generation confirmation information includes the identity information of the second terminal user, the identity information of the first terminal user, and the payment authorization information. The payment server 30 parses the generation confirmation information to extract necessary information therefrom for subsequent processing.

The payment server 30 then verifies the identity information.

For example, the payment server 30 checks whether the identity information provided by the second terminal user is valid, which may include the name, ID number, mobile phone number, etc., of the second terminal user, and may confirm its authenticity by calling the third-party identity verification service.

Meanwhile, the payment server 30 also verifies the identity information of the first terminal user, ensuring that the first terminal user has corresponding payment ability and credit status. This usually involves interaction with the bank or the payment platform where the payment account of the first terminal user is located.

The payment server 30 then carefully audits the payment authorization information which specifically includes the following.

Authorized amount: it should be ensured that the authorized amount is greater than or equal to the requested amount to meet the payment demand of the second terminal user.

Period of validity of authorization: a reasonable time range is set in which the second terminal user may use the temporary payment code for payment. After the period of validity expires, the payment code will become invalid, preventing misuse.

Authorization object: it specifies that the temporary payment code is only suitable for the second terminal user, preventing it from being used by other unauthorized third party.

After verifying and auditing all the necessary information, the payment server 30 begins to generate the temporary payment code. This process typically involves the following steps:
Data encryption: in order to ensure the security of data, the payment server 30 encrypts the identity information of the second terminal user, the identity information of the first terminal user, and the payment authorization information. The encrypted data will be used as a part of the temporary payment code.
Generation of unique identifier: in order to ensure the uniqueness of each temporary payment code, the payment server 30 generates a unique identifier (e.g., UUID). This identifier will be used as a core part of the temporary payment code for subsequent payment verification and tracking.
Creation of temporary payment code: the payment server 30 combines the encrypted data, the unique identifier, the payment authorization information, and other information that may be needed (e.g., a payment channel identifier, or coupon code) in a predetermined format to generate the temporary payment code associated with the second terminal user. This payment code may be presented in the form of a QR code, a bar code or a numerical string.

After generating the temporary payment code, the payment server 30 delivers the temporary payment code to the first terminal 10. After receiving the temporary payment code, the first terminal 10 sends it to the second terminal 20 so that the second terminal user presents the temporary payment code to the scanning device 40 when performing the payment operation.

In the entire process, the payment server 30 strictly complies with the relevant security criteria and regulatory requirements, ensuring the security, compliance, and traceability of the transaction process. Meanwhile, the payment server 30 records detailed transaction logs for auditing and investigation when needed.

In some embodiments, the method further includes: obtaining a payment request that is generated by scanning the temporary payment code and sent by a scanning device, where the payment request includes payment request time, amount to be paid, the unique identifier and the payment authorization information corresponding to the temporary payment code; upon determining that the payment request is valid according to the unique identifier and the payment authorization information, performing deduction processing on a payment account corresponding to the first terminal user according to the amount to be paid in the payment request; and feeding back deduction success information corresponding to the deduction processing to the first terminal, the second terminal, and the scanning device.

In further operation of the payment system, after scanning the temporary payment code, the scanning device 40 (e.g., the POS machine, the self-checkout terminal, or the camera of the mobile device) generates and sends the payment request to the payment server 30.

The scanning device 40 may read the information in the temporary payment code via its built-in scanning function (e.g., a QR code scanner). Such information typically includes the encrypted data, the unique identifier (e.g., UUID), the payment authorization information, and possible other metadata. The scanning device 40 parses the data in the temporary payment code and hereby generates the payment request. The payment request includes a plurality of pieces of key information, such as the payment request time (i.e., the specific time of scanning and sending the request), the amount to be paid (determined according to a transaction demand), the unique identifier corresponding to the temporary payment code (for verifying the validity of the payment code), and the payment authorization information (e.g., the authorized amount or the period of validity of authorization). The scanning device 40 then sends the generated payment request to the payment server 30 via the network for further processing.

After receiving the payment request, the payment server 30 first verifies it according to the unique identifier and the payment authorization information therein. This step aims to confirm whether the payment request is initiated by a valid temporary payment code and whether the amount to be paid in the payment request is within the range of the authorized amount, while checking whether the payment request is within the period of validity of authorization.

If the payment request is verified as valid, the payment server 30 will perform the deduction operation. This step involves deducting the amount to be paid from the payment account corresponding to the first terminal user. The payment server 30 interacts with the bank or the payment platform where the account of the first terminal user is located to ensure that the deduction operation is performed successfully.

The payment server 30 records all the relevant information of the current transaction, including the payment request time, the information of the first terminal user, the information of the second terminal user, the deducted amount, the transaction status, etc. These records may be used for subsequent businesses such as auditing and reconciliation.

The payment server 30 feeds back the deduction success information to the first terminal 10, allowing the first terminal user to know the payment status. This is typically achieved by sending a notification message, updating a payment page, or triggering a prompt in a specific app.

Although the payment request is not directly initiated by the second terminal user, the payment server 30 notifies the second terminal 20 of the deduction success information so that the second terminal user confirms that the payment has been completed and receives a corresponding service or commodity.

The scanning device 40, as a physical place or tool where the transaction takes place, also needs to receive the feedback of deduction success. This is conducive to ensuring the completeness of the transaction process, and provides data support for subsequent transaction statistics, report generation, etc.

By the above steps, the payment system can effectively process the payment request initiated by scanning the temporary payment code, ensuring the security and timeliness of the transaction. Moreover, with a timely information feedback mechanism, the first terminal user, the second terminal user and the scanning device 40 can know the transaction status in time. Thus, the user experience is enhanced.

In some embodiments, determining that the payment request is valid according to the unique identifier and the payment authorization information includes: determining, by the payment server, that the payment request is valid in response to the payment request time being within the period of validity of authorization, the amount to be paid being less than or equal to the authorized amount, and the unique identifier carried by the payment request matching the unique identifier included in the temporary payment code on the payment server.

Whether the payment request time is within the period of validity of authorization is verified.

The period of validity of authorization is a valid time period in which the temporary payment code is authorized for payment. The payment request can be accepted and processed only in this time period.

The payment server 30 checks the timestamp (i.e., the payment request time) carried in the payment request and compares it with the period of validity of authorization of the temporary payment code recorded on the payment server 30. If the payment request time is within the period of validity of authorization, the request is considered as valid in terms of time.

Whether the amount to be paid is less than or equal to the authorized amount is verified.

The authorized amount refers to maximum amount by which the temporary payment code is authorized for payment. The amount to be paid in the payment request should not exceed this limit.

The payment server 30 extracts the amount to be paid in the payment request and compares it with the authorized amount of the temporary payment code recorded on the payment server 30. If the amount to be paid is less than or equal to the authorized amount, the request is considered as valid in terms of amount.

Whether the unique identifier carried by the payment request matches the unique identifier included in the temporary payment code on the payment server is verified. The unique identifier is the unique identification of the temporary payment code and used for ensuring that the payment request is initiated by the valid payment code.

The payment server 30 extracts the unique identifier carried in the payment request and searches for the corresponding temporary payment code record in its database. If the matched unique identifier is found and the status of the payment code is valid (i.e., not used, or not expiring), the request is considered as valid in terms of identity.

If the above three verification steps are successful, the payment server 30 comprehensively determines the payment request as valid. This means that the payment request meets the requirements of the payment system in terms of time, amount, and identity, and the subsequent deduction processing can be performed.

Once the payment request is determined as valid, the payment server 30 will perform the deduction operation to deduct the amount to be paid from the payment account corresponding to the first terminal user. After the deduction is successful, the payment server 30 will generate the deduction success information and send it to each of the first terminal 10 (the terminal of the first terminal user), the second terminal 20 (the terminal of the second terminal user), and the scanning device 40 so as to notify the relevant parties of the payment result.

By these strict verification steps, the payment system can ensure the authenticity and validity of the payment request, thus protecting the fund security and the transaction order of both parties of payment.

If any condition is not met, the payment server will reject the payment request, and may return corresponding error information to the first terminal 10 or the scanning device 40, indicating the reason that the payment request is rejected. Such a verification mechanism ensures the security and accuracy of the payment process, preventing unauthorized payment behavior.

In some embodiments, before performing the deduction processing on the payment account corresponding to the first terminal user according to the amount to be paid in the payment request, the method further includes: sending a deduction verification request to the first terminal, where the deduction verification request is configured for the first terminal user to perform deduction verification; and upon obtaining in a preset time period deduction verification information that is fed back by the first terminal in response to the deduction verification request, performing the deduction processing on the payment account corresponding to the first terminal user according to the amount to be paid in the payment request.

In order to further enhance the security of the payment process and the user experience, the payment system adds the deduction verification step before performing the deduction operation. This step aims to ensure that the first terminal user is aware of and agrees with the forthcoming deduction activity definitely.

For example, after receiving and preliminarily verifying the payment request (e.g., with respect to the payment request time, the amount, and the unique identifier), but before actually performing the deduction processing on the payment account, the payment server 30 sends the deduction verification request to the first terminal (e.g., a smart phone or a tablet computer) used by the first terminal user.

The deduction verification request usually includes basic information about the payment request, such as a merchant name, a commodity description, and the amount to be paid, so that the first terminal user knows the details of the forthcoming transaction. The main purpose of this is to allow the first terminal user to confirm whether the current payment is authorized, preventing maloperation or unauthorized payment behavior.

After receiving the deduction verification request, the first terminal user may respond via the payment app or the relevant interface on the first terminal 10. The ways of responding may include a plurality of identity verification ways such as inputting a password, fingerprint verification, and face recognition, depending on the security policy of the payment system and the user's settings.

The payment server 30 sets a preset time period (e.g., several seconds to several minutes) and waits for the first terminal user to feed back the deduction verification information. This time period provides enough time for the first terminal user to perform the verification operation and avoids too long waiting time from affecting the payment efficiency.

The deduction verification information refers to information for confirming payment sent to the payment server 30 after the first terminal user passes the identity verification. This usually is a signal encrypted or processed with a specific algorithm, indicating that the first terminal user agrees with this payment.

After the payment server 30 successfully obtains in the preset time period the deduction verification information fed back by the first terminal 10 in response to the deduction verification request, and verifies that the information is valid, the payment server 30 performs the deduction operation.

The payment server 30 deducts the corresponding amount from the payment account corresponding to the first terminal user according to the amount to be paid in the payment request. After the deduction is successful, the payment server 30 generates the deduction success information and notifies the relevant parties (e.g., the first terminal 10 used by the first terminal user, the second terminal 20 used by the second terminal user, and the scanning device 30) of this information.

By adding the deduction verification step, the payment system can improve the security of the payment process to a certain extent and reduce the risks of unauthorized payments. Moreover, the reasonable preset time period and the diversified identity verification ways are also conducive to enhancing the user experience, rendering the payment process more convenient and efficient. This deduction verification process effectives guarantees the security of the payment process and the user's fund security by enhancing the active participation and the identity verification of the first terminal user.

In some embodiments, the method further includes: when the deduction verification information fed back by the first terminal in response to the deduction verification request is not obtained in the preset time period, generating deduction failure information; and feeding back the deduction failure information to the first terminal, the second terminal, and the scanning device.

In order to ensure the completeness of the payment process and the continuity of the user experience, when processing the deduction verification request, the payment server 30 particularly focuses on whether the deduction verification information from the first terminal 10 can be obtained successfully in the preset time period. If no effective feedback is obtained in this preset time period, the system will take a series of measures to duly handle this case and send a corresponding notification to the relevant parties.

For example, after sending the deduction verification request, the payment server 30 activates a timer to monitor the end of the preset time period. If the payment server 30 does not receive any response from the first terminal 10 or the received response does not meet expectations (e.g., verification failure or incomplete verification information) in this preset time period, the deduction verification is considered as expired.

Once the deduction verification is confirmed to have expired, the payment server 30 immediately generates the deduction failure information. This information includes a reason of transaction failure (e.g., verification expired), a transaction identifier (e.g., an order number or a transaction time), and other information that may be needed, so that the relevant parties know the details of the transaction failure.

For example, the payment server 30 sends the deduction failure information back to the first terminal 10, i.e., the device used by the first terminal user. Thus, the first terminal user may immediately know that the transaction is not completed successfully.

In certain scenarios, there may be a second terminal 20 which is configured to present the temporary payment code and ready for the payment operation with the temporary payment code. Likewise, the payment server 30 sends the deduction failure information to the second terminal 20 so that the second terminal user unable to pay with a payment code knows the transaction statuses and requests necessary assistance from the first terminal user in time.

For example, the payment server 30 also sends the deduction failure information to the scanning device 40. The scanning device 40 is thus caused to scan the temporary payment code again to initiate a payment request again.

In some embodiments, the method further includes: if the temporary payment code is a one-time payment code, labeling, by the payment server, a use status of the temporary payment code as disabled according to the deduction success information; or if the temporary payment code is a non-one-time payment code, updating, by the payment server, a balance for the temporary payment code according to the deduction success information, where the balance is used for next payment; and labeling the use status of the temporary payment code as disabled until the balance is zero.

Regarding the processing mechanism of the temporary payment code, the payment server 30 performs different subsequent operations according to the type of the temporary payment code (one-time payment code or non-one-time payment code) so as to ensure the security and efficiency of the payment process.

The one-time payment code means that it can only be used once, and will become invalid and cannot be used again once the deduction is successful. Upon receiving the deduction success information from the payment channel, the payment server 30 first confirms that this information corresponds to the transaction with the one-time payment code. Once confirming that the deduction is successful, the payment server 30 immediately labels the use status of the one-time payment code as “disabled”. This step prevents the temporary payment code from being reused maliciously, thus guaranteeing the authenticity and security of the transaction.

For example, the payment server 30 further records the relevant log of this alteration operation, including the payment code information, the transaction time, the transaction amount, the operation type (disabling), etc., for subsequent auditing and query.

The non-one-time payment code, e.g., an advance payment code or a payment code that can be reused for a certain number of times, this type of payment code typically has a preset balance or a limit of the number of uses. The payment server 30 first confirms that the deduction success information corresponds to the transaction with the non-one-time payment code. After confirming that the deduction is successful, the payment server 30 deducts the corresponding amount from the current balance of the payment code according to the transaction amount and updates its balance. This step ensures that the balance of the payment code is real-time and accurate. The balance is used as the usable balance for next payment until the balance is completely exhausted. As the transaction proceeds, the payment server 30 continues to check the balance of the payment code. When the balance decreases to zero, the payment server 30 automatically labels the use status of the payment code as “disabled”. By doing so, the payment failure due to insufficient balance may be prevented, and meanwhile, it is also avoided that the user unknowingly continues to try to use the invalid payment code.

In certain embodiments, it is also possible for the payment server 30 to send a balance reminding notification to the user when the balance of the payment code is approximate to a preset threshold so that the user recharges the account or adjusts the manner of payment in time.

For example, the payment server 30 also records all the key operation logs in the transaction process with the non-one-time payment code, including recharging, deduction, balance updating, disabling, etc., for subsequent query and auditing.

By the above processing process, the payment server 30 can flexibly process transactions with different types of temporary payment codes, thereby guaranteeing the authenticity and security of the transactions and improving the user experience and the payment efficiency.

In some embodiments, the method further includes: obtaining, by the payment server, a modification request made by the first terminal user via the first terminal for the generated temporary payment code; if the generated temporary payment code is not used, updating, by the payment server, the temporary payment code according to the modification request; and delivering, by the payment server, the updated temporary payment code to the first terminal so that the first terminal sends the updated temporary payment code to the second terminal.

In order to improve the flexibility of payment and enhance the user experience, the payment server 30 supports the function of modifying the generated temporary payment code. This function allows the first terminal user to adjust the relevant information of the payment code under specific conditions (e.g., the temporary payment code has not been used yet).

For example, the first terminal user initiates the modification request for the generated temporary payment code via the first terminal 10 (e.g., a smart phone, a tablet computer, or a smart watch) used by the first terminal user. This request may be triggered by the user directly tapping on the button “modify the temporary payment code” or selecting a similar option on the interface of the payment app.

The modification request includes the specific content needing to be modified, such as a period of validity for modifying the payment code, a payment limit, and coding of the payment code itself (on the premise of a certain rule or security). Such information is input or selected by the first terminal user and sent to the payment server 30 via the first terminal 10.

After receiving the modification request, the payment server 30 first verifies the status of the temporary payment code, i.e., confirms whether the payment code has been used. If the payment code has been used for payment and the deduction is successful, the payment server 30 will reject the modification request because the security and integrity of the payment code cannot be modified once it has been used.

If the payment code is not used, the payment server 30 will correspondingly update the temporary payment code according to the specific content in the modification request. This may include updating the valid time of the payment code and the payment limit, or generating new payment code (keeping a certain association with the original payment code at the same time for tracking and management).

In the modification process, the payment server 30 may perform a series of security checks to ensure that the modification operation does not introduce any security risk. For example, if the request includes the new payment code, the payment server 30 will verify whether the generation of the code conforms to the given security criteria and rules.

Once the modification operation is completed and all the necessary checks are successful, the payment server 30 delivers the updated temporary payment code information to the first terminal 10. This is typically achieved via network transmission (e.g., HTTP request/response), ensuring the rapid transfer and accuracy of the information.

After receiving the updated payment code, the first terminal 10 presents this change to the first terminal user via its user interface. Meanwhile, the first terminal user may select to send the updated payment code to the second terminal 20. The ways of sending may include QR code scanning, NFC touch, link copying and pasting, etc.

The payment server 30 supports the function of modifying the generated temporary payment code, providing higher flexibility and convenience for the first terminal user. With strict verification and security check mechanisms, this function ensures the security and reliability of the payment process while enhancing the user experience.

In some embodiments, the method further includes: obtaining a cancel request made by the first terminal user via the first terminal for the generated temporary payment code; if the generated temporary payment code is not used, canceling the temporary payment code according to the cancel request; and delivering a cancel notification for the temporary payment code to the first terminal so that the first terminal sends the cancel notification to the second terminal.

In order to ensure the flexibility and security of the payment process, the payment server 30 also provides the function of canceling the generated temporary payment code. This function allows the first terminal user to send the cancel request to the payment server 30 via the first terminal 10 in specific cases (e.g., where the payment code is no longer needed or there is a potential security risk) so as to cancel the validity of the payment code.

For example, the first terminal user initiates the cancel request for the generated temporary payment code via the first terminal 10 (e.g., a smart phone, a tablet computer, or a smart watch) used by the first terminal user. This request may be triggered by the user directly tapping on the button “cancel the temporary payment code” or selecting a similar option on the interface of the payment app.

The cancel request typically includes the unique identifier information of the temporary payment code needing to be canceled so that the payment server 30 can accurately identify and process the request. Such information is a part of the temporary payment code itself.

After receiving the cancel request, the payment server 30 first verifies the status of the temporary payment code. The key is to confirm whether the payment code has been used. If the payment code has been used for payment and the deduction is successful, the payment server 30 may be unable to directly cancel it (because the transaction has been completed). However, if the temporary payment code has not been used yet, the payment server 30 will be able to continue processing the cancel request.

Once confirming that the temporary payment code is not used, the payment server 30 will label the temporary payment code as “canceled” according to the information in the cancel request. This means that the temporary payment code will be no longer accepted in the subsequent transaction, thus ensuring the security and accuracy of the transaction.

The payment server 30 records the related information of the cancel operation, including a cancel time, a source of the cancel request, a canceled payment code identifier, etc., for subsequent auditing and tracking.

After the cancel operation is completed, the payment server 30 delivers the cancel notification to the first terminal 10. This notification may include confirmation information of cancel success, the canceled payment code identifier, and other related description.

After receiving the cancel notification, the first terminal 10 presents this information to the first terminal user via its user interface. The first terminal user may select to send the cancel notification to the second terminal 20 so that the relevant parties know that the payment code has been canceled. The ways of sending may include QR code scanning, notifying via a short message, instant messaging, etc., depending on the preferences of the first terminal user and the second terminal user and the available communication channel.

In some embodiments, the method further includes: upon determining that the temporary payment code expires according to the current time and the payment authorization information, invalidating the temporary payment code.

In order to enhance the security and controllability of the payment process, the payment server 30 monitors and manages the period of validity of the temporary payment code. When specific conditions are met, e.g., the current time exceeds the period of validity of the temporary payment code specified in the payment authorization information, the payment server 30 will automatically invalidate the payment code.

For example, when generating the temporary payment code, the payment server 30 sets a period of validity of authorization in the payment authorization information based on a request from the first terminal user or a system rule. The period of validity of authorization may be a fixed time period (e.g., 5 minutes, 10 minutes, or 1 day).

The payment server 30 maintains an accurate time system to ensure all time-related operations can be performed based on a uniform time base. This is conducive to avoiding wrong determination of the period of validity due to a time difference.

The payment server 30 checks a relationship between the current time and the period of validity of authorization of the temporary payment code specified in the payment authorization information regularly or in real time. This is typically achieved by comparing the current time with the end time of the period of validity of authorization.

If the current time exceeds the end time of the period of validity of authorization, the payment server 30 will determine that the temporary payment code has expired. At this point, the payment server 30 will no longer accept the payment request initiated with the temporary payment code to ensure the security and accuracy of the transaction.

Once confirming that the temporary payment code has expired, the payment server 30 will invalidate the payment code. This usually includes labeling the status of the payment code as “expired” or “invalid”, and removing from the system or archiving all the sensitive information related to the temporary payment code to prevent misuse or leakage.

The payment server 30 may send a notification to the first terminal user, informing that the temporary payment code has expired and suggesting generation of a new payment code. Meanwhile, the payment server 30 records the related information of invalidation, including an invalidation time, an invalidation reason, a payment code identifier, etc., for subsequent auditing and tracking.

By automatically invalidating the expired temporary payment code, the payment server 30 can effectively prevent potential security risks, e.g., the payment code being used maliciously or leaked.

In order to better illustrate the payment system provided by the embodiments of the present disclosure, with reference to FIG. 5, the flow of the payment method provided by the embodiments of the present disclosure may be summarized as the following steps.
S1. The second terminal user unable to pay with a payment code generates a generation request for a temporary payment code using a payment app configured on a second terminal, where the generation request includes identity information of the second terminal user and requested amount.
S2. The second terminal sends the generation request to a first terminal.
S3. The first terminal displays thereon a confirmation page of the temporary payment code in response to the generation request for a temporary payment code from the second terminal, and receives generation confirmation information input on the confirmation page by a first terminal user able to pay with a payment code. The generation confirmation information includes the identity information of the second terminal user, identity information of the first terminal user, and payment authorization information for use by the second terminal user.
S4. The first terminal sends the generation confirmation information to a payment server.
S5. The payment server generates a temporary payment code associated with the second terminal user according to the generation confirmation information, where the temporary payment code includes a unique identifier and the payment authorization information.
S6. The payment server delivers the temporary payment code to the first terminal.
S7. The first terminal sends the received temporary payment code to the second terminal.
S8. The second terminal presents the temporary payment code to a scanning device when performing a payment operation.
S9. The scanning device scans the temporary payment code and then generates a payment request, and sends the payment request to the payment server. The payment request includes payment request time, amount to be paid, a unique identifier and the payment authorization information corresponding to the temporary payment code.
S10. The payment server determines whether the payment request is valid according to the unique identifier and the payment authorization information.
S11. The payment server sends, upon determining that the payment request is valid, a deduction verification request to the first terminal. The deduction verification request is configured for the first terminal user to perform deduction verification.
S12. The first terminal feeds back deduction verification information to the payment server in response to the deduction verification request.
S13. The payment server performs, upon obtaining the deduction verification information fed back by the first terminal in response to the deduction verification request in a preset time period, deduction processing on a payment account corresponding to the first terminal user according to the amount to be paid in the payment request.
S14. The payment server feeds back deduction success information corresponding to the deduction processing to the first terminal, the second terminal, and the scanning device.

Regarding the implementation of the steps in the embodiments of the present disclosure, a reference may be made to the specific implementation of any of the above method embodiments, which will not be described here redundantly.

All the technical solutions described above can be arbitrarily combined to form optional embodiments of the present disclosure, which are not described one by one herein.

According to the embodiments of the present disclosure, the payment server obtains the generation confirmation information for a temporary payment code sent by the first terminal user able to pay with a payment code via the first terminal, where the generation confirmation information is generated by the first terminal according to the generation request from the second terminal user and includes the identity information of the second terminal user, the identity information of the first terminal user, and the payment authorization information for use by the second terminal user. The generation request is the generation request for a temporary payment code sent by the second terminal user unable to pay with a payment code to the first terminal via the second terminal, and includes the identity information of the second terminal user and the requested amount. The temporary payment code associated with the second terminal user is generated according to the generation confirmation information, where the temporary payment code includes the unique identifier and the payment authorization information. The temporary payment code is delivered to the first terminal so that the first terminal sends the temporary payment code to the second terminal for the second terminal user to perform the payment operation. According to the embodiments of the present disclosure, by allowing the first terminal user able to pay with a payment code to generate the temporary payment code for the second terminal user, the flexibility and the application range of the mode of payment are expanded. The problem that the second terminal user cannot make payments directly using payment codes due to technical or device restrictions. The payment process is simplified. The convenience of payment is improved. The generated temporary payment code includes the unique identifier and the payment authorization information, ensuring the authenticity, validity and security of payment.

In order to better implement the payment method of the embodiments of the present disclosure, an embodiment of the present disclosure further provides a payment apparatus. An embodiment of the present disclosure further provides a payment apparatus. With reference to FIG. 6, FIG. 6 is a first structural schematic diagram of a payment apparatus provided by an embodiment of the present disclosure. The payment apparatus 400 may be applied to the first terminal 10 in the payment system shown in FIG. 1. The payment apparatus 400 may include: a display unit 410 configured to display, in response to a generation request for a temporary payment code from a second terminal, a confirmation page of the temporary payment code on a first terminal, where the generation request includes identity information of a second terminal user and requested amount; a receiving unit 420 configured to receive generation confirmation information input on the confirmation page by a first terminal user able to pay with a payment code, where the generation confirmation information includes the identity information of the second terminal user, identity information of the first terminal user, and payment authorization information for use by the second terminal user; and a processing unit 430 configured to generate the temporary payment code according to the generation confirmation information, and send the temporary payment code to the second terminal so that the second terminal can use the temporary payment code, where the temporary payment code includes a unique identifier and the payment authorization information.

In some embodiments, the receiving unit 420 may be configured to: obtain payment authorization information for use by the second terminal user that is input by the first terminal user based on an authorization information editing interface displayed on the confirmation page, where the payment authorization information includes at least authorized amount, a period of validity of authorization, and an authorization object for the second terminal user, and the authorized amount is greater than or equal to the requested amount; and generate the generation confirmation information for a temporary payment code according to the identity information of the second terminal user, the identity information of the first terminal user, and the payment authorization information.

In some embodiments, the payment authorization information further includes the authorized use times and/or the authorized use position range.

In some embodiments, the processing unit 430 may be configured to: send the generation confirmation information to a payment server so that the payment server generates the temporary payment code associated with the second terminal user according to the generation confirmation information, where the temporary payment code includes the unique identifier and the payment authorization information; and obtain the temporary payment code delivered by the payment server, and send the temporary payment code to the second terminal so that the second terminal can perform a payment operation using the temporary payment code.

In some embodiments, the processing unit 430 may further be configured to: obtain deduction success information corresponding to deduction processing fed back by the payment server, where the deduction processing is implemented by the payment server performing the following operations: the payment server obtaining a payment request that is generated by scanning the temporary payment code and sent by a scanning device, the payment request including payment request time, amount to be paid, the unique identifier and the payment authorization information corresponding to the temporary payment code; and upon determining that the payment request is valid according to the unique identifier and the payment authorization information, the payment server performing the deduction processing on a payment account corresponding to the first terminal user according to the amount to be paid in the payment request.

In some embodiments, the processing unit 430 may be further configured to: before obtaining the deduction success information corresponding to the deduction processing fed back by the payment server, obtain a deduction verification request sent by the payment server, where the deduction verification request is used for the first terminal user to perform deduction verification; and generate deduction verification information in response to the deduction verification request in a preset time period, and send the deduction verification information to the payment server so that the payment server performs the deduction processing on the payment account corresponding to the first terminal user according to the deduction verification information and the amount to be paid in the payment request.

In some embodiments, the processing unit 430 may be further configured to: send to the payment server a modification request made by the first terminal user for the generated temporary payment code so that the payment server updates the temporary payment code according to the modification request when determining that the generated temporary payment code is not used; and obtain the updated temporary payment code delivered by the payment server, and send the updated temporary payment code to the second terminal.

In some embodiments, the processing unit 430 may be further configured to: send to the payment server a cancel request made by the first terminal user for the generated temporary payment code so that the payment server cancels the temporary payment code according to the cancel request when determining that the generated temporary payment code is not used; and obtain a cancel notification for the temporary payment code delivered by the payment server, and send the cancel notification to the second terminal.

In some embodiments, the second terminal user is a user unable to pay with a payment code.

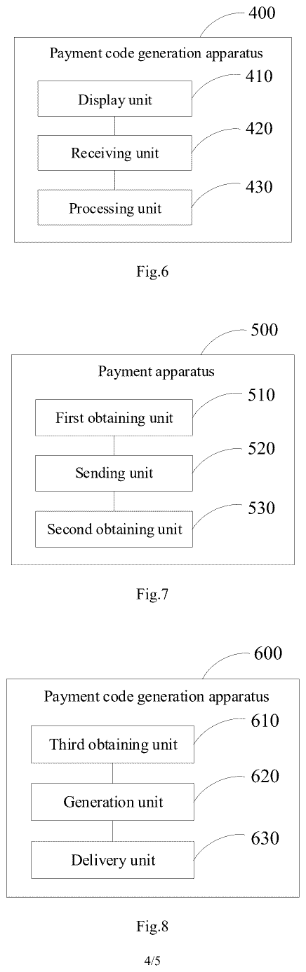

With reference to FIG. 7, FIG. 7 is a second structural schematic diagram of a payment apparatus provided by an embodiment of the present disclosure. The payment apparatus 500 may be applied to the second terminal 20 in the payment system shown in FIG. 1. The payment apparatus 500 may include: a first obtaining unit 510 configured to obtain a generation request for a temporary payment code input by a second terminal user, where the generation request includes identity information of the second terminal user and requested amount; a sending unit 520 configured to send the generation request to a first terminal so that the first terminal displays, in response to the generation request, thereon a confirmation page of the temporary payment code, and receives generation confirmation information input on the confirmation page by a first terminal user able to pay with a payment code and generates the temporary payment code according to the generation confirmation information, where the generation confirmation information includes the identity information of the second terminal user, identity information of the first terminal user, and payment authorization information for use by the second terminal user, and the temporary payment code includes a unique identifier and the payment authorization information; and a second obtaining unit 530 configured to obtain the temporary payment code sent by the first terminal for use by the second terminal user to perform a payment operation.

In some embodiments, the first obtaining unit 510 may be configured to: present a request editing interface for a temporary payment code; and obtain the generation request for a temporary payment code input by the second terminal user based on the request editing interface, where the generation request includes the identity information of the second terminal user and the requested amount.

In some embodiments, the first obtaining unit 510 may be configured to: display a candidate first terminal user list on the request editing interface, where the candidate first terminal user list is configured for the second terminal user to select a first terminal user matching the temporary payment code from the candidate first terminal user list; and obtain the generation request for a temporary payment code input by the second terminal user based on the request editing interface, where the generation request includes the identity information of the second terminal user, the requested amount, and identity information of the first terminal user.

In some embodiments, the first obtaining unit 510 may be configured to: generate the candidate first terminal user list according to intimate degrees of the second terminal user with candidate first terminal users; or generate the candidate first terminal user list according to interaction frequencies of the second terminal user with candidate first terminal users.

In some embodiments, the payment apparatus 500 may be further configured to: present the temporary payment code to a scanning device so that the scanning device scans the temporary payment code to generate a payment request and sends the payment request to the payment server, where the payment request includes payment request time, amount to be paid, the unique identifier and the payment authorization information corresponding to the temporary payment code; and obtain, by the second terminal, deduction success information corresponding to deduction processing fed back by the payment server, where the deduction processing refers to that, upon determining that the payment request is valid according to the unique identifier and the payment authorization information, the payment server performs the deduction processing on a payment account corresponding to the first terminal user according to the amount to be paid in the payment request.

In some embodiments, the payment apparatus 500 may be further configured to: receive invalidation information of the temporary payment code after the scanning device scans the temporary payment code; generate a new generation request for a temporary payment code according to the invalidation information; send the new generation request for a temporary payment code to the first terminal so that the first terminal displays thereon the confirmation page of the temporary payment code in response to the new generation request, and receives new generation confirmation information input on the confirmation page by the first terminal user able to pay with a payment code and generates a new temporary payment code according to the new generation confirmation information, where the new generation confirmation information includes the identity information of the second terminal user, the identity information of the first terminal user able to pay with a payment code, and new payment authorization information for use by the second terminal user, and the new temporary payment code includes a unique identifier and the new payment authorization information; and obtain the new temporary payment code sent by the first terminal for use by the second terminal user to perform the payment operation.

With reference to FIG. 8, FIG. 8 is a third structural schematic diagram of a payment apparatus provided by an embodiment of the present disclosure. The payment apparatus 600 may be applied to the payment server 30 in the payment system shown in FIG. 1. The payment apparatus 600 may include: a third obtaining unit 610 configured to obtain generation confirmation information sent by a first terminal user able to pay with a payment code via a first terminal, where the generation confirmation information is for a temporary payment code and is generated by the first terminal according to a generation request from a second terminal user, the generation confirmation information includes identity information of the second terminal user, identity information of the first terminal user, and payment authorization information for use by the second terminal user, and the generation request includes the identity information of the second terminal and requested amount; a generation unit 620 configured to generate the temporary payment code associated with the second terminal user according to the generation confirmation information, where the temporary payment code includes a unique identifier and the payment authorization information; and a delivery unit 630 configured to deliver the temporary payment code to the first terminal so that the first terminal sends the temporary payment code to the second terminal for use by the second terminal user to perform the payment operation.

In some embodiments, the generation unit 620 may be configured to: obtain the identity information of the second terminal user, the identity information of the first terminal user, and the payment authorization information according to the generation confirmation information, where the payment authorization information includes authorized amount, a period of validity of authorization, and an authorization object for the second terminal user, and the authorized amount is greater than or equal to the requested amount; and generate the temporary payment code associated with the second terminal user according to the identity information of the second terminal user, the identity information of the first terminal user, and the payment authorization information.

In some embodiments, the payment apparatus 600 is further configured to: obtain a payment request that is generated by scanning the temporary payment code and sent by a scanning device, where the payment request includes payment request time, amount to be paid, the unique identifier and the payment authorization information corresponding to the temporary payment code; upon determining that the payment request is valid according to the unique identifier and the payment authorization information, perform deduction processing on a payment account corresponding to the first terminal user according to the amount to be paid in the payment request; and feed back deduction success information corresponding to the deduction processing to the first terminal, the second terminal, and the scanning device.

In some embodiments, when determining that the payment request is valid according to the unique identifier and the payment authorization information, the payment apparatus 600 may be configured to: determine that the payment request is valid in response to the payment request time being within the period of validity of authorization, the amount to be paid being less than or equal to the authorized amount, and the unique identifier carried by the payment request matching the unique identifier included in the temporary payment code on the payment server.

In some embodiments, the payment apparatus 600 may further be configured to: before performing the deduction processing on the payment account corresponding to the first terminal user according to the amount to be paid in the payment request, send a deduction verification request to the first terminal, where the deduction verification request is configured for the first terminal user to perform deduction verification; and upon obtaining in a preset time period deduction verification information that is fed back by the first terminal in response to the deduction verification request, perform the deduction processing on the payment account corresponding to the first terminal user according to the amount to be paid in the payment request.

In some embodiments, the payment apparatus 600 may further be configured to: when the deduction verification information fed back by the first terminal in response to the deduction verification request is not obtained in the preset time period, generate deduction failure information; and feed back the deduction failure information to the first terminal, the second terminal, and the scanning device.

In some embodiments, the payment apparatus 600 may further be configured to: if the temporary payment code is a one-time payment code, label a use status of the temporary payment code as disabled according to the deduction success information; or if the temporary payment code is a non-one-time payment code, update a balance for the temporary payment code according to the deduction success information, where the balance is used for next payment; and label the use status of the temporary payment code as disabled until the balance is zero.

In some embodiments, the payment apparatus 600 may further be configured to: obtain a modification request made by the first terminal user via the first terminal for the generated temporary payment code; if the generated temporary payment code is not used, update the temporary payment code according to the modification request; and deliver the updated temporary payment code to the first terminal so that the first terminal sends the updated temporary payment code to the second terminal.

In some embodiments, the payment apparatus 600 may further be configured to: obtain a cancel request made by the first terminal user via the first terminal for the generated temporary payment code; if the generated temporary payment code is not used, cancel the temporary payment code according to the cancel request; and deliver a cancel notification for the temporary payment code to the first terminal so that the first terminal sends the cancel notification to the second terminal.

In some embodiments, the payment apparatus 600 may further be configured to: upon determining that the temporary payment code expires according to the current time and the payment authorization information, invalidate the temporary payment code.

The payment apparatus 400, the payment apparatus 500 or the payment apparatus 600 may be integrated into a terminal device or server that has a memory and is installed with a processor to have the computing power. Alternatively, the payment apparatus 400, the payment apparatus 500 or the payment apparatus 600 may be the terminal device or the server.

In some embodiments, the present disclosure further provides a computer device including a memory and a processor. The memory stores a computer program which, when executed by the processor, implements the steps in the above method embodiments.

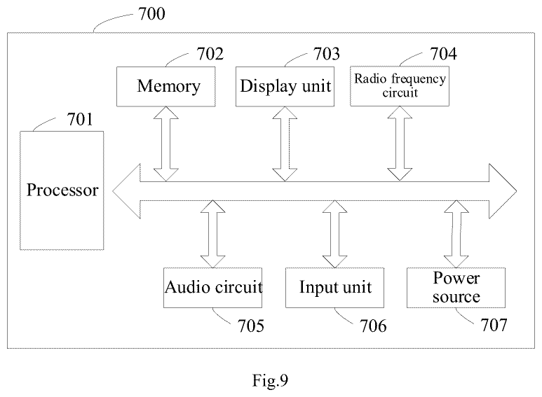

In some embodiments, as shown in FIG. 9, FIG. 9 is another structural schematic diagram of a computer device provided by the embodiments of the present disclosure. The computer device 700 further includes a processor 701 having one or more processing cores, a memory 702 having one or more computer-readable storage mediums, and a computer program stored on the memory 702 and runnable on the processor. The processor 701 is electrically connected to the memory 702. It will be understood by those skilled in the art that the structure of the computer device as shown in the figure does not constitute a limitation on the computer device, which may include more or less components than those shown in the figure, or some components are combined, or different component arrangements are provided.

The processor 701 is a control center of the computer device 700, connects to various parts of the computer device 700 by using various interfaces and lines, and performs various functions and data processing of the computer device 700 by running or loading software programs and/or modules stored in the memory 702 and calling data stored in the memory 702, so as to perform overall monitoring on the computer device 700.

Optionally, the computer device 700 may be a first terminal. The processor 701 may call software programs and/or modules stored in the memory 702 to perform the following operations:
displaying a confirmation page of the temporary payment code on a first terminal in response to a generation request for a temporary payment code from a second terminal, the generation request including identity information of a second terminal user and requested amount; receiving generation confirmation information input on the confirmation page by a first terminal user able to pay with a payment code, the generation confirmation information including the identity information of the second terminal user, identity information of the first terminal user, and payment authorization information for use by the second terminal user; and generating the temporary payment code according to the generation confirmation information, and sending the temporary payment code to the second terminal so that the second terminal can use the temporary payment code, the temporary payment code including a unique identifier and the payment authorization information.

Optionally, the computer device 700 may be a second terminal. The processor 701 may call software programs and/or modules stored in the memory 702 to perform the following operations: obtaining a generation request for a temporary payment code input by a second terminal user, where the generation request includes identity information of the second terminal user and requested amount; sending the generation request to a first terminal so that the first terminal displays thereon a confirmation page of the temporary payment code in response to the generation request, and receives generation confirmation information input on the confirmation page by a first terminal user able to pay with a payment code and generates the temporary payment code according to the generation confirmation information, where the generation confirmation information includes the identity information of the second terminal user, identity information of the first terminal user, and payment authorization information for use by the second terminal user, and the temporary payment code includes a unique identifier and the payment authorization information; and obtaining the temporary payment code sent by the first terminal for use by the second terminal user to perform a payment operation.

Optionally, the computer device 700 may be a payment server. The processor 701 may call software programs and/or modules stored in the memory 702 to perform the following operations: obtaining generation confirmation information sent by a first terminal user able to pay with a payment code via a first terminal, where the generation confirmation information is for a temporary payment code and is generated by the first terminal according to a generation request for a temporary payment code from a second terminal user, the generation confirmation information includes identity information of the second terminal user, identity information of the first terminal user, and payment authorization information for use by the second terminal user, and the generation request includes the identity information of the second terminal and requested amount; generating the temporary payment code associated with the second terminal user according to the generation confirmation information, where the temporary payment code includes a unique identifier and the payment authorization information; and delivering the temporary payment code to the first terminal so that the first terminal sends the temporary payment code to the second terminal, enabling the second terminal to use the temporary payment code.

Regarding to specific implementations of the above various operations, see the foregoing embodiments, which will be described redundantly here.

In some embodiments, as shown in FIG. 9, the computer device 700 further includes a display unit 703, a radio frequency circuit 704, an audio circuit 705, an input unit 706, and a power source 707. The processor 701 is electrically connected to each of the display unit 703, the radio frequency circuit 704, the audio circuit 705, the input unit 706, and the power source 707. It will be understood by those skilled in the art that the structure of the computer device shown in FIG. 9 does not constitute a limitation on the computer device, which may include more or less components than those shown in the figure, or some components are combined, or different component arrangements are provided.

The display unit 703 may be configured to display information input by or provided to the user and various graphic user interfaces of the computer device, where these graphic user interfaces may be constituted by graphs, texts, icons, videos, and any combinations thereof. The display unit 703 may include a display panel and a touch panel.

The radio frequency circuit 704 may be configured to receive and transmit radio frequency signals so as to establish wireless communication with a network device or other computer devices via wireless communication and receive and transmit signals with the network device or the other computer devices.

The audio circuit 705 may be configured to provide an audio interface between the user and the computer device via a speaker or a microphone. The audio circuit 705 may transmit an electrical signal that is converted from the received audio data to the speaker, and the electrical signal is converted into an acoustical signal by the speaker. On the other hand, the microphone converts the collected acoustical signal into the electrical signal which is received by the audio circuit 705 and then converted into the audio data. The audio data is then output to the processor 701 for processing and sent to, e.g., another computer device via the radio frequency circuit 704. Alternatively, the audio data is output to the memory for further processing. The audio circuit 705 may further include an earplug jack to provide communication between peripheral earphones and the computer device.

The input unit 706 may be configured to receive input digital or character information or object feature information (e.g., fingerprint, iris, or facial information) and generate keyboard, mouse, joystick, optical or trackball signal inputs associated with user settings and function control.

The power source 707 is configured to supply power to various components of the computer device 700.

Although not shown in FIG. 9, the computer device 700 may further include a camera, a sensor, a wireless fidelity module, a Bluetooth module, etc., which will not be described redundantly here.

In some embodiments, the present disclosure further provides a computer-readable storage medium for storing a computer program. The computer-readable storage medium may be applied to a terminal device or a server, and the computer program causes the terminal device or the server to perform the corresponding processes of the method in the embodiments of the present disclosure, which will not be described redundantly here for brevity.

In some embodiments, the present disclosure further provides a computer program product, including a computer program stored in a computer-readable storage medium. A processor of a computer device reads the computer program from the computer-readable storage medium. The processor executes the computer program, causing the computer device to perform the corresponding processes of the method in the embodiments of the present disclosure, which will not be described redundantly here for brevity.

The present disclosure further provides a computer program, including a computer program stored in a computer-readable storage medium. A processor of a computer device reads the computer program from the computer-readable storage medium. The processor executes the computer program, causing the computer device to perform the corresponding processes of the method in the embodiments of the present disclosure, which will not be described redundantly here for brevity.

It should be appreciated that the processor in the embodiments of the present disclosure may be an integrated circuit chip capable of signal processing. During the implementation, the steps of each of the above method embodiments may be performed by using an integrated logic circuit of hardware in a processor or by using instructions in a form of software. The processor may be a general-purpose processor, a digital signal processor (DSP), an application-specific integrated circuit (ASIC), a field-programmable gate array (FPGA), or other programmable logic device, a discrete gate or transistor logic device, or a discrete hardware component. The processor can implement or perform the methods, steps and logical block diagrams disclosed in the embodiments of the present disclosure. The general-purpose processor may be a microprocessor, or the processor may be any conventional processor, etc. The steps of the methods disclosed with reference to the embodiments of the present disclosure may be directly performed by a hardware decoding processor, or performed by a combination of hardware and software modules in the decoding processor. The software module may be located in a mature storage medium in the art, such as a random access memory, a flash memory, a read-only memory, a programmable read-only memory, an electrically erasable programmable memory, or a register. The storage medium is located in a memory. The processor reads information in the memory, and completes the steps of the above-described methods in combination with hardware in the processor.

It can be understood that the memory in the embodiments of the present disclosure may be a volatile memory or a non-volatile memory, or may include both a volatile memory and a non-volatile memory. The non-volatile memory may be ready-only memory (ROM), a programmable ROM (PROM), an erasable PROM (EPROM), an electrically EPROM (EEPROM), or a flash memory. The volatile memory may be a random access memory (RAM), which is used as an external cache. Through illustrative rather than restrictive description, RAMs of many forms are available, for example, a static RAM (SRAM), a Dynamic RAM (DRAM), a Synchronous DRAM (SDRAM), a Double Data Rate SDRAM (DDR SDRAM), an enhanced SDRAM (ESDRAM), synchlink DRAM (SLDRAM), and a direct rambus RAM (DRRAM). It should be noted that the memory involved in the systems and methods described in this specification is intended to include, but is not limited to, these memories and a memory of any other suitable type.

Those of ordinary skill in the art may be aware that units and algorithm steps in examples described with reference to the embodiments disclosed in this specification can be implemented by electronic hardware or a combination of computer software and electronic hardware. Whether these functions are implemented by using hardware or software depends on the specific application of the technical solutions and design constraints. A person skilled in the art may use different methods to implement the described functions for each specific application, but such an implementation should not be considered to be beyond the scope of the present disclosure.

A person skilled in the art can clearly understand that for convenience and brevity of description, references may be made to corresponding processes in the foregoing method embodiments for specific working processes of the foregoing systems, apparatuses, and units. Details are not described herein again.

The foregoing descriptions are merely specific implementations of the present disclosure, but the protection scope of the present disclosure is not limited thereto. Any variation or replacement readily figured out by a person skilled in the art within the technical scope disclosed in the present disclosure shall fall within the protection scope of the present disclosure. Therefore, the protection scope of the present disclosure should be subject to the protection scope of the claims.

1. A payment code generation method, comprising:
displaying, in response to a generation request for a temporary payment code from a second terminal, a confirmation page of the temporary payment code on a first terminal, wherein the generation request comprises identity information of a second terminal user and requested amount;
receiving generation confirmation information input on the confirmation page by a first terminal user able to pay with a payment code, wherein the generation confirmation information comprises the identity information of the second terminal user, identity information of the first terminal user, and payment authorization information for use by the second terminal user; and
generating the temporary payment code according to the generation confirmation information, and sending the temporary payment code to the second terminal so that the second terminal can use the temporary payment code, wherein the temporary payment code comprises a unique identifier and the payment authorization information.

2. The payment code generation method of claim 1, wherein the receiving the generation confirmation information input on the confirmation page by the first terminal user able to pay with the payment code comprises:
obtaining the payment authorization information for use by the second terminal user, wherein the payment authorization information is input by the first terminal user on an authorization information editing interface displayed on the confirmation page, the payment authorization information comprises at least authorized amount, a period of validity of authorization, and an authorization object for the second terminal user, and the authorized amount is greater than or equal to the requested amount; and
generating the generation confirmation information for the temporary payment code according to the identity information of the second terminal user, the identity information of the first terminal user, and the payment authorization information.

3. The payment code generation method of claim 2, wherein the payment authorization information further comprises authorized use times and/or an authorized use position range.

4. The payment code generation method of claim 1, wherein the generating the temporary payment code according to the generation confirmation information and sending the temporary payment code to the second terminal comprise:
sending the generation confirmation information to a payment server so that the payment server generates the temporary payment code associated with the second terminal user according to the generation confirmation information; and
obtaining the temporary payment code delivered by the payment server, and sending the temporary payment code to the second terminal so that the second terminal can perform a payment operation using the temporary payment code.

5. The payment code generation method of claim 4, further comprising:
obtaining deduction success information corresponding to deduction processing fed back by the payment server,
wherein the deduction processing is implemented by the payment server performing following operations:
the payment server obtaining a payment request generated by scanning the temporary payment code and sent by a scanning device, the payment request comprises payment request time, amount to be paid, the unique identifier and the payment authorization information corresponding to the temporary payment code, and the payment server, upon determining that the payment request is valid according to the unique identifier and the payment authorization information, performing the deduction processing on a payment account corresponding to the first terminal user according to the amount to be paid in the payment request.

6. The payment code generation method of claim 5, wherein before the obtaining the deduction success information corresponding to the deduction processing fed back by the payment server, the method further comprises:
obtaining a deduction verification request sent by the payment server, wherein the deduction verification request is used for the first terminal user to perform deduction verification; and
generating deduction verification information in response to the deduction verification request in a time period, and sending the deduction verification information to the payment server so that the payment server performs the deduction processing on the payment account corresponding to the first terminal user according to the deduction verification information and the amount to be paid in the payment request.

7. The payment code generation method of claim 1, further comprising:
sending to the payment server a modification request made by the first terminal user for the generated temporary payment code so that the payment server updates the temporary payment code according to the modification request in response to determining that the generated temporary payment code is not used; and
obtaining the updated temporary payment code delivered by the payment server, and sending the updated temporary payment code to the second terminal.

8. The payment code generation method of claim 1, further comprising:
sending to the payment server a cancel request made by the first terminal user for the generated temporary payment code so that the payment server cancels the temporary payment code according to the cancel request in response to determining that the generated temporary payment code is not used; and
obtaining a cancel notification for the temporary payment code delivered by the payment server, and sending the cancel notification to the second terminal.

9. The payment code generation method of claim 1, wherein the second terminal user is a user unable to pay with a payment code.

10. A payment method, comprising:
obtaining a generation request for a temporary payment code input by a second terminal user, wherein the generation request comprises identity information of the second terminal user and requested amount;
sending the generation request to a first terminal so that the first terminal displays, in response to the generation request, thereon a confirmation page of the temporary payment code, and receives generation confirmation information input on the confirmation page by a first terminal user able to pay with a payment code and generates the temporary payment code according to the generation confirmation information, wherein the generation confirmation information comprises the identity information of the second terminal user, identity information of the first terminal user, and payment authorization information for use by the second terminal user, and the temporary payment code comprises a unique identifier and the payment authorization information; and
obtaining the temporary payment code sent by the first terminal for use by the second terminal user to perform a payment operation.

11. The payment method of claim 10, wherein the obtaining the generation request for the temporary payment code input by the second terminal user comprises:
presenting a request editing interface for the temporary payment code; and
obtaining the generation request for the temporary payment code input by the second terminal user on the request editing interface, wherein the generation request comprises the identity information of the second terminal user and the requested amount.

12. The payment method of claim 11, further comprising:
displaying a candidate first terminal user list on the request editing interface, wherein the candidate first terminal user list is configured for the second terminal user to select a first terminal user matching the temporary payment code from the candidate first terminal user list; and the generation request further comprises the identity information of the first terminal user.

13. The payment method of claim 12, further comprising:
generating the candidate first terminal user list according to intimate degrees of the second terminal user with candidate first terminal users; or
generating the candidate first terminal user list according to interaction frequencies of the second terminal user with candidate first terminal users.

14. The payment method of claim 10, further comprising:
presenting the temporary payment code to a scanning device so that the scanning device scans the temporary payment code to generate a payment request and sends the payment request to a payment server, wherein the payment request comprises payment request time, amount to be paid, the unique identifier and the payment authorization information corresponding to the temporary payment code; and
obtaining deduction success information corresponding to deduction processing fed back by the payment server,
wherein the deduction processing refers to that the payment server performs, upon determining that the payment request is valid according to the unique identifier and the payment authorization information, the deduction processing on a payment account corresponding to the first terminal user according to the amount to be paid in the payment request.

15. The payment method of claim 14, further comprising:
receiving invalidation information of the temporary payment code after the scanning device scans the temporary payment code;
generating a new generation request for the temporary payment code according to the invalidation information;
sending the new generation request for the temporary payment code to the first terminal so that the first terminal displays, in response to the new generation request, thereon a confirmation page of the temporary payment code, and receives new generation confirmation information input on the confirmation page by the first terminal user able to pay with a payment code and generates a new temporary payment code according to the new generation confirmation information, wherein the new generation confirmation information comprises the identity information of the second terminal user, the identity information of the first terminal user able to pay with a payment code, and new payment authorization information for use by the second terminal user, and the new temporary payment code comprises a unique identifier and the new payment authorization information; and
obtaining the new temporary payment code sent by the first terminal for use by the second terminal user to perform the payment operation.

16. A payment code generation method, comprising:
obtaining generation confirmation information sent by a first terminal user able to pay with a payment code via a first terminal, wherein the generation confirmation information is for a temporary payment code and is generated by the first terminal according to a generation request, the generation request is for the temporary payment code from a second terminal user, the generation confirmation information comprises identity information of the second terminal user, identity information of the first terminal user, and payment authorization information for use by the second terminal user, and the generation request comprises the identity information of a second terminal and requested amount;
generating the temporary payment code associated with the second terminal user according to the generation confirmation information, wherein the temporary payment code comprises a unique identifier and the payment authorization information; and
delivering the temporary payment code to the first terminal so that the first terminal sends the temporary payment code to the second terminal, enabling the second terminal to use the temporary payment code.

17. The payment code generation method of claim 16, further comprising:
obtaining a payment request generated by scanning the temporary payment code and sent by a scanning device, wherein the payment request comprises payment request time, amount to be paid, the unique identifier and the payment authorization information corresponding to the temporary payment code;
performing, upon determining that the payment request is valid according to the unique identifier and the payment authorization information, deduction processing on a payment account corresponding to the first terminal user according to the amount to be paid in the payment request; and
feeding back deduction success information corresponding to the deduction processing to the first terminal, the second terminal, and the scanning device.

18. A non-transitory computer-readable storage medium, storing a computer program, wherein the computer program, upon execution by a processor, causes the processor to perform the method of claim 1.

19. The storage medium of claim 18, wherein the receiving the generation confirmation information input on the confirmation page by the first terminal user able to pay with the payment code comprises:
obtaining the payment authorization information for use by the second terminal user, wherein the payment authorization information is input by the first terminal user on an authorization information editing interface displayed on the confirmation page, the payment authorization information comprises at least authorized amount, a period of validity of authorization, and an authorization object for the second terminal user, and the authorized amount is greater than or equal to the requested amount; and
generating the generation confirmation information for the temporary payment code according to the identity information of the second terminal user, the identity information of the first terminal user, and the payment authorization information.

20. A computer device, comprising a memory and a processor, wherein the memory stores a computer program, and the processor is configured to perform the method of claim 1 when the computer program stored in the memory is executed by the processor.
